(19) United States
(12) Patent Application Publication
(10) Pub. No.: US 2026/0126519 A1
(43) Pub. Date: May 7, 2026

(54) ANTENNA POSITION DETERMINATION SYSTEMS AND METHODS AND ASSOCIATED ANTENNA ARRAY

(71) Applicant: Teledyne FLIR Defense, Inc., Thousand Oaks, CA (US)

(72) Inventors: Patrick Lamontagne, Laval (CA); Michel Pelletier, Boisbriand (CA)

(21) Appl. No.: 19/369,804

(22) Filed: Oct. 27, 2025

Related U.S. Application Data
(63) Continuation of application No. PCT/US2024/026332, filed on Apr. 25, 2024.
(60) Provisional application No. 63/499,447, filed on May 1, 2023.

(51) Int. Cl. G01S 7/40; G01S 13/08

(52) U.S. Cl. CPC G01S 7/40; G01S 13/08

(57) ABSTRACT

Techniques are provided for antenna position determination systems and methods and associated antenna array. In one example, a method includes determining a first set of antenna positions associated with an antenna array. The method further includes determining at least one characteristic associated with the first set of antenna positions. The method further includes determining a score associated with the first set of antenna positions based on the at least one characteristic. The method further includes adjusting, based at least on the score, the first set of antenna positions to obtain a second set of antenna positions associated with the antenna array. Related systems are also provided.

### CROSS REFERENCE TO RELATED APPLICATIONS

This application is a continuation of International Patent Application No. PCT/US2024/026332 filed Apr. 25, 2024 and entitled “ANTENNA POSITION DETERMINATION METHOD, ASSOCIATED ANTENNA ARRAY AND RANGING SYSTEM,” which claims priority to and the benefit of U.S. Provisional Patent Application No. 63/499,447 filed May 1, 2023, and entitled “ANTENNA POSITION DETERMINATION SYSTEMS AND METHODS AND ASSOCIATED ANTENNA ARRAY,” all of which are incorporated herein by reference in their entirety.

### TECHNICAL FIELD

One or more embodiments relate generally to ranging systems and more particularly, for example, to antenna position determination systems and methods and associated antenna array.

### BACKGROUND

Ranging systems, such as radio detection and ranging (radar), sound navigation and ranging (sonar), light detection and ranging (lidar), and/or other remote sensing systems, are often used to assist in navigation and/or detect targets (e.g., objects, geographic features, or other types of targets), such as targets in proximity to watercraft, aircraft, vehicles, or fixed locations, by producing data and/or imagery of an environment. For example, radar systems may transmit (e.g., broadcast) radar signals and receive return signals. Such return signals may be based on reflections of the transmitted radar signals by targets.

### SUMMARY

In one or more embodiments, a method includes determining a first set of antenna positions associated with an antenna array. The method further includes determining at least one characteristic associated with the first set of antenna positions. The method further includes determining a score associated with the first set of antenna positions based on the at least one characteristic. The method further includes adjusting, based at least on the score, the first set of antenna positions to obtain a second set of antenna positions associated with the antenna array.

In one or more embodiments, a ranging system includes an antenna array configured to transmit ranging signals and/or receive ranging signals. The antenna array includes a single line of antenna elements arranged in a staggered arrangement in which the antenna elements are separated along a first direction and each antenna element is at a respective distance along a second direction from a first reference axis parallel to the first direction. The first direction is perpendicular to the second direction.

The scope of the present disclosure is defined by the claims, which are incorporated into this section by reference. A more complete understanding of embodiments of the present disclosure will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1A illustrates a block diagram of an example system that includes a radar system in accordance with one or more embodiments of the present disclosure.

FIG. 1B illustrates an example environment in which the radar system of FIG. 1A may be operated in accordance with one or more embodiments of the present disclosure.

FIG. 2 illustrates a graph depicting an example relationship between a mean ground sidelobes level and a ground sidelobe metric in accordance with one or more embodiments.

FIG. 3 illustrates a flow diagram of an example process for positioning antenna elements of an antenna array in accordance with one or more embodiments of the present disclosure.

FIGS. 4 and 5 each illustrates an example antenna array with thirty-two antenna elements in a substantially symmetrical staggered arrangement in accordance with one or more embodiments of the present disclosure.

FIG. 6 illustrates an example antenna array with thirty-two antenna elements in an asymmetrical staggered arrangement in accordance with one or more embodiments of the present disclosure.

FIGS. 7 and 8 each illustrates an example antenna array with sixteen antenna elements in a substantially symmetrical staggered arrangement in accordance with one or more embodiments of the present disclosure.

FIG. 9 illustrates an example antenna array with sixteen antenna elements in an asymmetrical staggered arrangement in accordance with one or more embodiments of the present disclosure.

FIG. 10 illustrates an example antenna array with eight antenna elements in an asymmetrical staggered arrangement in accordance with one or more embodiments of the present disclosure.

FIG. 11 illustrates an example antenna array with eight antenna elements in a substantially symmetrical staggered arrangement in accordance with one or more embodiments of the present disclosure.

FIG. 12 illustrates a block diagram of a ranging system in accordance with one or more embodiments of the present disclosure.

FIG. 13 illustrates a diagram of an aerial survey system in accordance with one or more embodiments of the present disclosure.

FIG. 14 illustrates a diagram of a maritime survey system in accordance with one or more embodiments of the present disclosure.

Embodiments of the present disclosure and their advantages are best understood by referring to the detailed description that follows. It is noted that sizes of various components and distances between these components are not drawn to scale in the figures. It should be appreciated that like reference numerals are used to identify like elements illustrated in one or more of the figures.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, structures and components are shown in block diagram form in order to avoid obscuring the concepts of the subject technology. One or more embodiments of the subject disclosure are illustrated by and/or described in connection with one or more figures and are set forth in the claims.

Various techniques provide antenna position determining systems and methods and associated antenna array for ranging systems. A ranging system (e.g., a radar system) includes a transmit (TX) antenna array formed of one or more TX antenna elements and a receive (RX) antenna array formed of one or more RX antenna elements, in which the TX antenna array exhibits a TX radiation pattern and the RX antenna array exhibits an RX radiation pattern. The TX antenna array may be implemented based on TX antenna parameters and the RX antenna array may be implemented based on RX antenna parameters. In some aspects, one or more of the same antenna elements may be used to form a part of the TX antenna array as well as the RX antenna array. These antenna elements used in both the RX and TX antenna arrays may be referred to as transceiver antenna elements, which form a transceiver antenna array and are used both for transmitting as well as receiving radar signals. By way of non-limiting examples, the antenna parameters (e.g., TX and RX antenna parameters) may include an antenna element type (e.g., patch, dipole, slot, etc.) of each antenna element, a material(s) of each antenna element, a position and/or a disposition of each antenna element in the antenna array, a gain and/or phase shift associated with each antenna element, and/or generally any parameters that may affect the construction and/or application of the antenna array and, thus, the radiation pattern exhibited by the antenna array. In an aspect, antenna elements may be referred to as antennas, elements, radiating elements, and/or variants thereof. In an aspect, a radiation pattern may be based on, or may be referred to as, an antenna pattern, an antenna response, a field pattern, a power pattern (e.g., power is proportional to field squared), a far-field pattern, a beam shape, a beam pattern, and/or variants thereof (e.g., an antenna field response).

An antenna radiation pattern of an antenna array may be based on each antenna element's radiation pattern (e.g., also referred to as element factor) and an array factor of the antenna array. In an aspect, an antenna array may include a set of antenna elements that can be considered as working together as a single antenna element. In some applications, an antenna array may be a single antenna element. For the case that antenna elements of the antenna array are identical, or may be considered to be identical (e.g., approximately identical), an elevation radiation pattern of the antenna array may be given by

$$S ( ϕ ) = {S}_{e} ( ϕ ) * {S}_{a} ( ϕ )$$

where * represents a convolution, Sₑ(φ) is the antenna element's elevation radiation pattern, Sₐ(φ) is the array factor, and φ is an elevation angle of the antenna array.

Each antenna element's radiation pattern is based on properties relating to the antenna element's construction/composition, such as antenna element type (e.g., patch, dipole, slot, etc.), material(s) used to construct the antenna element, and disposition of the antenna element in the antenna array. In this regard, antenna element type, antenna element material(s), and/or disposition associated with the antenna elements may be selected to generate a desired radiation pattern of each antenna element and, in combination, a desired radiation pattern of the antenna array.

The foregoing description of the radiation pattern of the antenna arrays applies to a radiation pattern of a TX antenna array as well as a radiation pattern of an RX antenna array. In this regard, the radiation pattern of the TX antenna array and the RX antenna array may be given by S_{TX}(φ)=S_{e,TX}(φ)*S_{a,TX}(φ) and S_{RX}(φ)=S_{e,RX}(φ)*S_{a,RX}(φ), respectively, where S_{e,TX}(φ) may be different from S_{e,RX}(φ) and/or S_{a,TX}(φ) may be different from S_{a,RX}(φ). An antenna system radiation pattern is a combination of the radiation patterns of the TX antenna array and the RX antenna array and is given by

$${S}_{system} ( ϕ ) = {S}_{TX} ( ϕ ) * {S}_{RX} ( ϕ )$$

where * represents a convolution. In an aspect, the antenna system radiation pattern may be referred to as a system pattern, a system beam shape, a total system beam shape, a system response, an overall system beam shape, a system antenna pattern, a total system antenna pattern, and/or variants thereof (e.g., an overall antenna system response).

In some embodiments, an antenna array (e.g., a radar antenna array) may include multiple antenna elements arranged (e.g., arranged vertically) in a staggered antenna array pattern (e.g., also referred to simply as a staggered pattern). In an aspect, an arrangement of the antenna elements that form the antenna array may be referred to as an antenna array pattern, an array pattern, an antenna pattern, or a pattern. Performance figures/characteristics of an antenna array depend on a position of each of its antenna elements that collectively form the arrangement of the antenna elements, among other antenna parameters such as an antenna element type (e.g., patch, dipole, slot, etc.) of each antenna element, a material(s) of each antenna element, a gain and/or a phase shift associated with each antenna element, and/or generally any parameters that may affect the construction and/or application of the antenna array and, thus, a radiation pattern exhibited by the antenna array. By way of non-limiting examples, the performance figures may include a half-power azimuth beamwidth, half-power elevation beamwidth, level of ground sidelobes, level of sidelobes in the entire field of view (excluding the ground plane), and/or other characteristics.

In some embodiments, placement of a set of antenna elements in a single line may be performed to simultaneously achieve/optimize desired performance figures/characteristics (e.g., desired by a user of the antenna array and/or required by specification), as further described herein. In an aspect, a set of antenna elements in a single line may be referred to as a linear set of antenna elements. The placement of one or more of the antenna elements may be adjusted as appropriate to achieve desired performance figures/characteristics. Each of these performance figures (e.g., half-power elevation beamwidth, ability to reduce an impact of interference and/or multi-path effects with the ground or other objects, etc.) may be used to determine/compute a metric. These metrics may be combined (e.g., linear combination, non-linear combination) to generate a global score (e.g., also referred to as an antenna pattern score, a pattern score, or simply a score) that defines/provides a figure of merit of the array pattern.

Each metric may be associated with a weight. In this regard, the score may be based on a combination of each metric with its associated weight. Weights attributed to the different metrics may be different depending on an importance and/or a priority of each metric with respect to a global performance (e.g., associated with an application for which the antenna array is designed and to allow comparison of different antenna arrays with respect to one or more characteristics). The array pattern may be used in different applications, in which each application may associate a respective weight to be applied to each metric. For example, for a given application, a zero weight may be applied to a metric determined to be of no importance to the application or otherwise a metric that is to be ignored when determining the score of the array pattern.

Using various embodiments, an antenna position optimization process for optimizing the position of the antenna elements may simultaneously allow two-dimensional beamforming, achieving sufficient accuracy on both azimuth and elevation angles, obtaining low sidelobes at the ground level, reducing azimuth and/or elevation errors caused by multi-path effects with external objects, the ground, or the environment or other type of external interference, and so forth. In some embodiments, for a given antenna array, performance metrics may be determined based on the performance figures and, in turn, a score associated with the antenna array may be determined based on the performance metrics (e.g., a weighted combination of the metrics). In some cases, the optimization process may be performed in such a way that all desired performance characteristics are considered simultaneously at optimization time to provide better performance characteristics, such as better angular accuracies, while using fewer antenna elements (e.g., fewer receive antenna elements) than conventional approaches with multiple rows and multiple columns of antenna elements.

By contrast, in conventional approaches, many rows and many columns of antenna elements, along with associated complex electronic circuitry and large amount of processing power, are used to perform two-dimensional beamforming, with the number of elements on a plane (e.g., a horizontal plane) controlling the azimuth accuracy and the number of elements on a plane (e.g., a vertical plane) controlling the elevation accuracy. As such, to obtain a good accuracy in both the azimuth and elevation planes in such conventional approaches, a very large number of antenna elements and associated electronics and signal processing would be needed. Larger spacing between the elements may be used to increase the accuracy, but will cause grating lobes in the response. For air targets in the presence of interference and/or multi-path effects with the ground or other objects, the estimated elevation and/or azimuth angle can have large errors. To reduce these errors, many elements may be used in the vertical plane to have a narrow elevation beam that reduce energy associated with interference and/or multi-path effects with the ground or other objects, but this comes at the expense of either a large total number of receive elements or a very limited number of receive elements in the azimuth plane. For the conventional approaches, shaping of a beam in one dimension, usually the elevation plane, requires many elements in this dimension. As such, for example, given a fixed number of receive antenna elements, improving the angular in one axis results in a large degradation of accuracy in the other axis. Also, the ability to mitigate/reduce the impact of interference and/or multi-path effects (e.g., with the ground or other objects) on the elevation axis usually requires a very small beamwidth in the elevation axis and a large number of elements in the vertical axis. This in turn increases the azimuth beamwidth or increases the number of rows and thus the total number of receive antenna elements.

Although various embodiments are described primarily with reference to antennas and antenna arrays for transmitting and/or receiving electromagnetic waves, such as in radar antennas and radar antenna arrays, one or more embodiments may also apply to antennas and antenna arrays for transmitting and/or receiving mechanical waves, such as sound waves. Such embodiments may be utilized, for instance, in sonar applications. In some aspects, the antennas and antenna arrays may be used in radar systems, sonar systems, lidar systems, and/or generally any systems in which detection and/or ranging may be desired. Furthermore, methods and systems disclosed herein may be utilized in conjunction with devices and systems such as imaging systems having visible-light and infrared imaging capability, short-wave infrared (SWIR) imaging systems, millimeter wavelength (MMW) imaging systems, ultrasonic imaging systems, X-ray imaging systems, microscope systems, mobile digital cameras, video surveillance systems, video processing systems, or other systems or devices that may need to obtain image data in one or multiple portions of the electromagnetic spectrum.

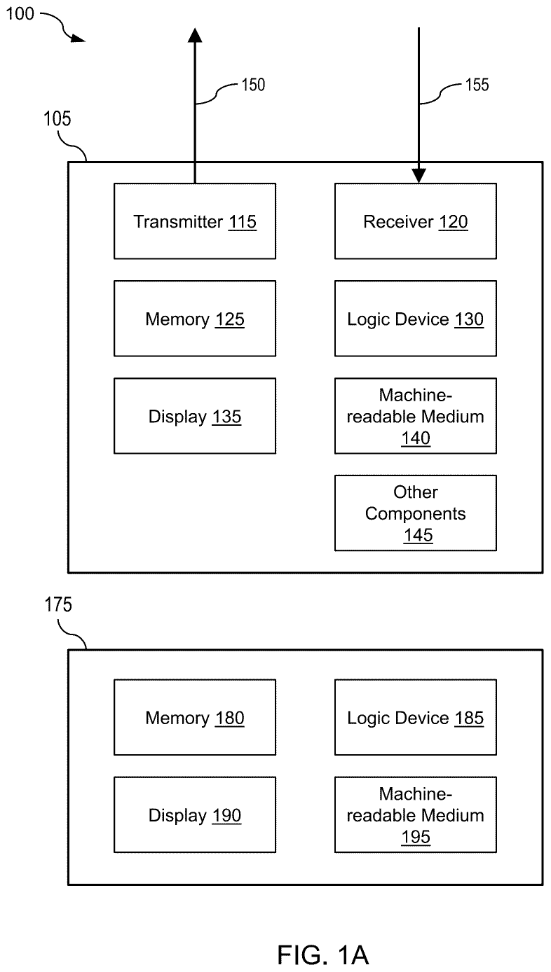

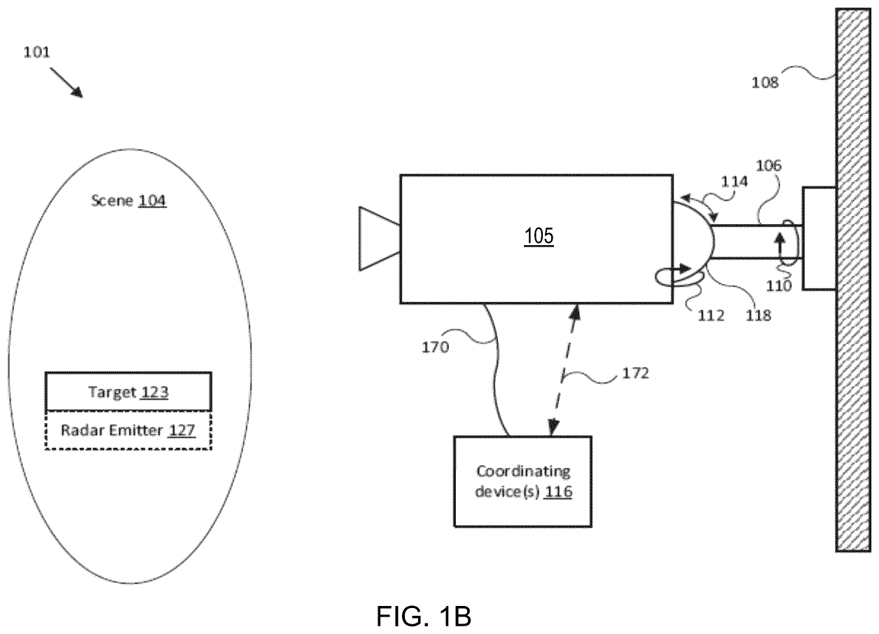

Referring now to the drawings, FIG. 1A illustrates a block diagram of a system 100 in accordance with one or more embodiments of the present disclosure. Variations in the arrangement and type of the components may be made without departing from the spirit or scope of the claims as set forth herein. Additional components, different components, and/or fewer components may be provided. The system 100 includes a radar system 105. In various embodiments, the radar system 105 may be configured for use on aircraft, watercraft, terrestrial vehicles, construction machinery (e.g., cranes), fixed locations such as buildings, or other environments, and may be used for various applications such as, for example, leisure, commercial, military navigation and/or security. Other types of navigation and/or security and additional applications are also contemplated. In one aspect, the radar system 105 may be implemented as a relatively compact portable unit that may be conveniently installed by a user. As some examples, the radar system 105 may be installed in a mobile device, on a building or other physical structure, and on a vehicle. In some embodiments, the radar system 105 may be implemented to provide radar data for a mobile structure, such as a drone, a watercraft, an aircraft, a robot, a vehicle, and/or other types of mobile structures, including any platform designed to move through or under the water, through the air, and/or on a terrestrial surface.

The radar system 105 includes a transmitter circuitry 115, a receiver circuitry 120, a memory 125, a logic device 130, a display 135, a machine-readable medium 140, and other components 145. In an aspect, a radar device may include the transmitter circuitry 115 and the receiver circuitry 120, with the remaining components of the radar system 105 referred to as associated circuitry/components of the radar device. In some cases, the radar device may include other components shown in FIG. 1A, such as the memory 125 and/or the logic device 130. The transmitter circuitry 115 includes one or more TX antenna elements and appropriate circuitry to generate radar signals and provide such radar signals to the TX antenna elements, such that these radar signals can be transmitted by the TX antenna elements. Such transmitted radar signals are denoted as signals 150 of FIG. 1A. The transmitter circuitry 115 may include a waveform generator that generates various waveforms to be utilized as radar signals. Such waveforms may include pulses of various lengths (e.g., different pulse widths), frequency-modulated continuous-wave (FMCW) signals, and/or other waveforms appropriate for radar applications. FMCW signals may be implemented, by way of non-limiting examples, as rising, falling, or rising/falling frequency sweeps (e.g., upchirps, downchirps, or up/down chirps). The transmitter circuitry 115 may include one or more power amplifiers that receive the radar signals from the waveform generator and drive the radar signals on the TX antenna element(s) of the transmitter circuitry 115. In some cases, characteristics of the radar signals may be based at least in part from control signals received by the logic device 130. In some embodiments, the transmitter circuitry 115 may include an antenna array with multiple antenna elements arranged in a staggered antenna array pattern, as further described herein.

The receiver circuitry 120 may include one or more RX antenna elements (e.g., phased array antennas) and circuitry to process radar signals received by the RX antenna elements. Such received radar signals are denoted as signals 155 in FIG. 1A. The RX antenna elements can receive the radar signals 155, which may be reflections of the transmitted radar signals 150 from targets/objects in a scene or detection area or radar signals emitted directly from the targets/objects. In some cases, the received radar signals 155 that were reflected from a target/object may be referred to as received return signals. The receiver circuitry 120 may include appropriate circuitry to process these received signals. The receiver circuitry 120 may include one or more low-noise amplifiers (LNAs) for amplifying the received radar signals 155. The receiver circuitry 120 may include a demodulator to receive the radar signals 155 and convert the received radar signals 155 to baseband. In some cases, the demodulator may generate I signals and Q signals based on the received radar signals 155. The receiver circuitry 120 may include filters (e.g., low-pass filters) to be applied to the radar signals (e.g., baseband radar signals). The receiver circuitry 120 may include an analog-to-digital (ADC) circuit to convert the received radar signals 155, or filtered versions thereof, which are analog signals, to digital radar signals. The digital radar signals may be provided to the logic device 130 for further processing to facilitate radar applications (e.g., target detection applications). In some embodiments, the receiver circuitry 120 may include an antenna array with multiple antenna elements arranged in a staggered antenna array pattern, as further described herein. In some aspects, one or more of the same antenna elements may be used to form a part of the TX antenna array as well as the RX antenna array and thus form part of the transmitter circuitry 115 as well as the receiver circuitry 120. These antenna elements used in both the RX and TX antenna arrays may be referred to as transceiver antenna elements, which form a transceiver antenna array and are used both for transmitting as well as receiving radar signals.

The logic device 130 may be implemented as any appropriate processing device (e.g., microcontroller, processor, application specific integrated circuit (ASIC), logic device, field-programmable gate array (FPGA), circuit, or other device) that may be used by the radar system 105 to execute appropriate instructions, such as non-transitory machine readable instructions (e.g., software) stored on the machine-readable medium 140 and loaded into the memory 125. For example, on an RX side, the logic device 130 may be configured to receive and process radar data received by the receiver circuitry 120, store the radar data, processed radar data, and/or other data associated with the radar data in the memory 125, and provide the radar data, processed radar data, and/or other data associated with the radar data for processing, storage, and/or display. In this example, outputs of the logic device 130 may be, or may be derived into, representations of processed radar data that can be displayed by the display 135 for presentation to one or more users. On a TX side, the logic device 130 may generate radar signals or associated signals to cause radar signals to be generated and fed to the transmitter circuitry 115, such that these radar signals can be transmitted by the TX antenna element(s) of the transmitter circuitry 115. In an embodiment, the logic device 130 may be utilized to process radar return data (e.g., perform fast Fourier Transforms (FFTs), perform detection processing on FFT outputs) received via the receiver circuitry 120, generate target data, perform mitigation actions if appropriate in response to the target data, and/or other operations.

The memory 125 includes, in one embodiment, one or more memory devices configured to store data and information, including radar data. The memory 125 may include one or more various types of memory devices including volatile and non-volatile memory devices, such as random access memory (RAM), dynamic RAM (DRAM), static RAM (SRAM), non-volatile random-access memory (NVRAM), read-only memory (ROM), programmable read-only memory (PROM), erasable programmable read-only memory (EPROM), electrically-erasable programmable read-only memory (EEPROM), flash memory, hard disk drive, and/or other types of memory. As discussed above, the logic device 130 may be configured to execute software instructions stored in the memory 125 so as to perform method and process steps and/or operations. The logic device 130 may be configured to store in the memory 125 data such as, by way of non-limiting examples, scores associated with antenna patterns, filter coefficients, beamforming coefficients, and object/target detection data.

The display 135 may be used to present radar data, images, or information received or processed by the radar system 105. In one embodiment, the display 135 may be a multifunction display with a touchscreen configured to receive user inputs to control the radar system 105.

The radar system 105 may include various other components 145 that may be used to implement other features such as, for example, sensors, actuators, communications modules/nodes, other user controls, communication with other devices, additional and/or other user interface devices, and/or other components. In some embodiments, other components 145 may include a humidity sensor, a wind and/or water temperature sensor, a barometer, a visible spectrum camera, an infrared camera, a compass, an altimeter, a GPS tracking device and/or other sensors and devices providing measurements and/or other sensor signals that can be displayed to a user and/or used by other devices of radar system 105 to provide operational control of the radar system 105 such as for installation and calibration purposes. For example, such sensor signals may be utilized to compensate for environmental conditions, such as wind speed and/or direction; swell speed, amplitude, and/or direction; and/or an object in a path (e.g., line of sight) of the radar system 105. Imagers (e.g., visible spectrum camera, infrared camera) may be utilized to provide situational awareness of a scene, such as by providing image data associated with captured radar data. Further, the images may provide calibration information that may be used in a calibration process. In some cases, sensor information can be used to correct for movement (e.g., changes in position, orientation, and/or speed) associated with the radar system 105 between beam emissions to provide improved alignment of corresponding radar returns/samples, for example, and/or to generate imagery based on the measured orientations and/or positions of the radar system 105 assembly/antennas. In some cases, an external orientation and/or position sensor can be used alone or in combination with an integrated sensor or sensors. In some cases, alternatively or in addition to having sensors and/or other devices as part of the radar system 105, the sensors and/or other devices may be collocated with the radar system 105. Such sensors and/or other devices may provide data to the radar system 105 (e.g., via wired and/or wireless communication).

In some cases, the radar system 105 may include one or more visible spectrum cameras and/or one or more infrared cameras, such as to capture image data of a scene scanned by the radar system 105. In one embodiment, the other components 145 includes a communication interface that may communicate with another device that may be implemented with some or all of the features of the radar system 105. Such communication may be performed through appropriate wired or wireless signals (e.g., Wi-Fi, Bluetooth, or other standardized or proprietary wireless communication techniques). In one example, the radar system 105 may be located at a first position (e.g., on a bridge of a watercraft in one embodiment) and may communicate with a personal electronic device (e.g., a cell phone, tablet, computer, etc.) located at a second position (e.g., co-located with a user on another location on the watercraft). In this regard, the user's personal electronic device may receive radar data and/or other information from the radar system 105. As a result, the user may conveniently receive relevant information (e.g., radar images, alerts, notifications, installation feedback, calibration information, or other information) even while not in proximity to the radar system 105. Information related to installation and calibration of the radar system 105 or component thereof may be provided for display to the user for example. In an implementation, the user may have an application installed on a user device which may receive real time installation feedback as the user is installing the radar system 105 and present such feedback to the user on a display of the user interface to assist the user in installing the radar system 105. Since the user device may be used to help coordinate installation of the radar system 105, the user device may be referred to as a coordinating user device or simply a coordinating device. In an implementation, the application may provide calibration user interface to allow the user to proceed through instructed steps to calibrate the radar system 105. In further examples, the radar system 105 may include one or more light sources (e.g., light emitting diodes (LEDs)), such as to provide feedback to a user during an installation of the radar system 105. In yet further examples, the radar system 105 may include one or more speakers communicatively coupled to the logic device 130 and configured to provide audible feedback to the user during the installation of the radar system 105.

In some embodiments, the transmitter circuitry 115 and/or the receiver circuitry 120 may be used to implement adaptive beamforming and antenna arrays. The transmitter circuitry 115 and/or the receiver circuitry 120 may be provided as an array of antenna elements, such as an array having multiple rows and multiple columns of antenna elements. One or more antenna elements may be selectively activated dependent on (e.g., to achieve) desired characteristics/application. In some cases, the array may include some antenna elements that are fixed (e.g., cannot be deactivated) in the array. In other cases, all the antenna elements in the array can be selectively activated or deactivated. In some aspects, one or more of the same antenna elements may be used to form a part of the TX antenna array as well as the RX antenna array.

In some embodiments, the logic device 130 may be used to implement/design the transmitter circuitry 115 and/or the receiver circuitry 120. The logic device 130 may be configured to generate TX and/or RX antenna parameters to be utilized to physically construct and/or configure a TX antenna array and/or RX antenna array of an antenna system. Such physical construction and/or configuring of the TX antenna array and/or RX antenna array may involve selectively activating the antenna elements of the array. In some aspects, the logic device 130 may determine positions of an antenna array's antenna elements to activate and determine characteristics, metrics, and/or scores associated with the antenna array based on an iterative process, in which the positions of antenna elements of the antenna array are adjusted (e.g., by adjusting which antenna elements of the antenna array are activated versus deactivated in the array) as appropriate to effectuate desired antenna array characteristics/behavior. In some aspects, the selectively activated antenna elements are in a staggered pattern.

By way of non-limiting examples, the logic device 130 may control antenna parameters such as a number of antenna elements to be used in a TX antenna array, a number of antenna elements to be used in an RX antenna array, a position of each of the antenna elements, material properties of each of the antenna elements, gain to be applied to each of the antenna elements (e.g., via an amplifier and/or passive circuitry), phase shift to be applied to each of the antenna elements (e.g., via a phase shifter), and/or other antenna parameters. To reduce computational complexity, some antenna parameters may be fixed (e.g., rather than variable). In this regard, the number of degrees of freedom may be, or may be indicative of, the number of individual parameters that can be adjusted to influence a system beam shape or component thereof (e.g., TX antenna pattern, RX antenna pattern).

In other embodiments, the transmitter circuitry 115 and/or the receiver circuitry 120 may be a fixed antenna array. The system 100 includes an optional computing system 175 used to design a fixed antenna array(s). The computing system 175 is external to the radar system 105 and may be referred to as an external computing system or an external system. Once the computer system 175 determines a design of a fixed antenna array that effectuates desired antenna array characteristics/behavior, the antenna array may be manufactured according to the design, tested, and, if the manufactured antenna array effectuates the desired antenna array characteristics/behavior, provided in a radar system (e.g., the radar system 105) as part of a transmitter circuitry (e.g., the transmitter circuitry 115) and/or a receiver circuitry (e.g., the receiver circuitry 120).

The computing system 175 may include a memory 180, a logic device 185, a display 190, and/or a machine-readable medium 195. Description of the memory 125, the logic device 130, the display 135, and the machine-readable medium 140 of the radar system 105 generally applies to the memory 180, the logic device 185, the display 190, and the machine-readable medium 195 of the computing system 175, respectively. The logic device 185 may be used to execute appropriate instructions, such as non-transitory machine readable instructions (e.g., software) stored on the machine-readable medium 195 and loaded into the memory 180, such as instructions that define method and process steps and/or operations pertaining to designing and testing antenna arrays. The display 190 may be used to present data to the user to facilitate the design and testing processes, such as allow the user to manually adjust antenna parameters (e.g., antenna positions, antenna gain, etc.), desired characteristics, and so forth.

The logic device 185 may generate antenna array designs and determine characteristics associated with the array designs by running simulations (e.g., using Matlab and/or other design tool) on the designs. In this regard, the logic device 185 may be configured to generate a design to be utilized to physically construct and/or configure a TX antenna array and/or RX antenna array of an antenna system by determining TX and/or RX antenna parameters. By way of non-limiting examples, the logic device 185 may control antenna parameters such as a number of antenna elements to be used in a TX antenna array, a number of antenna elements to be used in an RX antenna array, a position of each of the antenna elements, material properties of each of the antenna elements, gain to be applied to each of the antenna elements (e.g., via an amplifier and/or passive circuitry), phase shift to be applied to each of the antenna elements (e.g., via a phase shifter), and/or other antenna parameters. To reduce computational complexity, some antenna parameters may be fixed (e.g., rather than variable). In this regard, the number of degrees of freedom may be, or may be indicative of, the number of individual parameters that can be adjusted to influence a system beam shape or component thereof (e.g., TX antenna pattern, RX antenna pattern).

In some aspects, the antenna parameters include positions of an antenna array's antenna elements, among other parameters. The logic device 185 may determine positions of an antenna array's antenna elements and characteristics, metrics, and/or scores associated with the antenna array based on an iterative antenna position optimization process, in which the positions of the antenna elements are adjusted as appropriate to effectuate desired antenna array characteristics/behavior. In this regard, the logic device 185 may run simulations with the antenna elements arranged according to the set of antenna positions associated with each iteration of the antenna position optimization process. In some aspects, the fixed antenna elements are in a staggered pattern.

FIG. 1B illustrates an example environment 101 in which the radar system 105 may be operated. The example environment 101 includes the radar system 105 and a coordinating device(s) 116. In the illustrated embodiment of FIG. 1B, the radar system 105 and the coordinating device 116 may communicate with each other over a wired connection 170 and/or a wireless connection 172 to perform various operations for automatic and/or manual installation and/or calibration. In some embodiments, the coordinating device 116 may be implemented in the radar system 105 to perform various operations for automatic and/or manual installation and/or calibration. In some cases, the coordinating device 116 may include LED devices, speakers, imagers, or a combination of devices, all of which individually, or in combination, may provide various forms of feedback to a user. For example, LED devices may provide visual feedback and speakers may provide audible feedback. In some instances, the coordinating device 116 may be a mobile user device that has a screen display and is capable of receiving installation feedback from the radar system 105 to display for the user as another form of visual feedback. The user device may also have speakers capable of providing audio instructions based on installation feedback.

As shown, the radar system 105 can be securely attached (e.g., fixed) to a structure 108 (e.g., a wall, ceiling, pole, vehicle, or other structure appropriate for installing the radar system 105 for purposes such as navigation and/or surveillance) via a mount 106 to monitor and/or track objects within a scene (e.g., a scene 104). The mount 106 in some cases may be adjustable to rotate or pivot the radar system 105 or devices thereof to adjust for a roll 110, a heading angle 112 (e.g., for panning), and/or a tilt angle 114. The adjustments provided by the mount 106 in these cases may facilitate installation of the radar system 105 on a variety of mounting points (e.g., including a corner of a room) at desired heading and/or tilt angles at an appropriate height. In one or more specific examples, the adjustable mount 106 may include a rotatable joint 118 (e.g., a ball joint) that allows rotation or pivoting in the directions 110, 112, and/or 114.

A target 123 in the scene 104 within a detection area of the radar system 105 may be used in installation and calibration techniques. In some cases, a radar emitter 127 may be installed on the target 123 or held by a user if the target 123 is a user. In further cases, the coordinating device 116 may include the radar emitter 127 such that the radar emitter 127 and the radar system 105 may sync radar signal transmission/receipt via the wireless connection 172.

In some embodiments, a ranging system (e.g., a radar system) includes one or more antenna arrays. An antenna array (e.g., a radar antenna array) may include multiple antenna elements arranged (e.g., arranged vertically) in a staggered antenna array pattern (e.g., also referred to simply as a staggered pattern). In some aspects, the antenna array may be a receive antenna array with multiple antenna elements that apply one or more beamforming vectors on received signals to generate receive beams. Each of these receive beams may be associated with (e.g., possess) and/or may be characterized using characteristics such as, by way of non-limiting examples, its half-power azimuth beamwidth, half-power elevation beamwidth, level of ground sidelobes, level of sidelobes in the entire field of view (excluding the ground plane), and/or other characteristics. In some cases, the array pattern may, alternatively or in addition, be associated with and/or characterized by characteristics associated with (e.g., indicative of) the array pattern's ability to reduce an impact of interference and/or multi-path effects with the ground or other objects and/or the array pattern's ability to model and remove these interference and/or multi-path effects. The array pattern's behavior with regard to the interference and/or multi-path effects (e.g., with the ground or other objects) may depend on a chosen method used to determine/compute an altitude of a target, such as multiple signal classification (MUSIC), estimation of signal parameters via rotational invariant techniques (ESPRIT), amplitude monopulse, and/or other methods.

In some aspects, one or more of the same antenna elements used to form the receive antenna array may also be used as a transmit antenna array. These antenna elements used in both the receive and transmit antenna arrays may be referred to as transceiver antenna elements, which form a transceiver antenna array and are used both for transmitting as well as receiving radar signals. In other aspects, the ranging system may include other antenna elements used as a transmit antenna array. The transmit antenna array may include multiple antenna arrangements arranged in a staggered antenna array pattern, a non-staggered antenna array pattern, or generally any array pattern capable of transmitting radar signals appropriate for a desired application. Characteristics described previously relating to receive beams are also generally applicable to transmit beams.

Each of these characteristics (e.g., half-power elevation beamwidth, ability to reduce an impact of multi-path effects and/or external interference, etc.) may be used to determine/compute a metric. These metrics may be combined (e.g., linear combination, non-linear combination) to generate a global score (e.g., also referred to as an antenna pattern score or simply a score) that defines/provides a figure of merit of the array pattern. Each metric may be associated with a weight. In this regard, the score may be based on a combination of each metric with its associated weight. Weights attributed to the different metrics may be different depending on an importance of each metric with respect to a global performance (e.g., associated with an application for which the antenna array is designed to be used). The array pattern may be used in different applications, in which each application may associate a respective weight to be applied to each metric. For example, for a given application, a zero weight may be applied to a metric determined to be of no importance to the application or otherwise a metric that is to be ignored when determining the score of the array pattern.

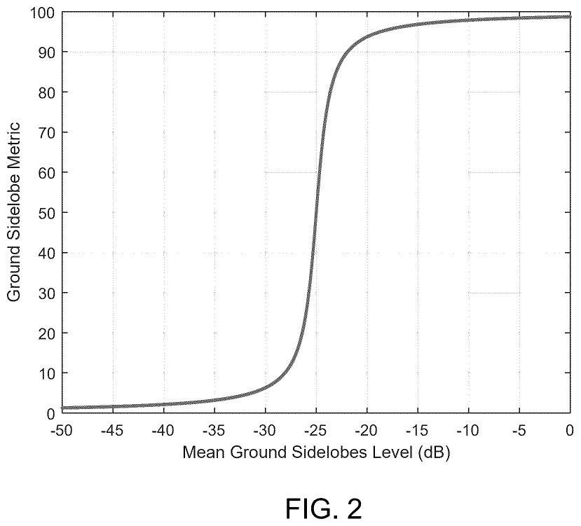

FIG. 2 illustrates a graph depicting an example relationship between a mean ground sidelobes level and a ground sidelobe metric in accordance with one or more embodiments. In general, an antenna array design may seek to minimize a sum of squares of all ground sidelobes. A sum of squares may be used rather than a sum of all ground sidelobes since the sum of squares allows each ground sidelobe to provide a positive value. The graph provides a correspondence between a mean ground sidelobes level in decibels (dB) with a corresponding value for a ground sidelobe metric. The ground sidelobe metric spans from a value of 0 to a value of 100. As examples, a mean ground sidelobe level of −25 dB corresponds to a ground sidelobe metric value of 50, a mean ground sidelobe level range of −30 dB to −20 dB spans a ground sidelobe metric value range of around 6 to around 94, and the ground sidelobe metric value converges toward a minimum value of 0 as the mean ground sidelobes level decreases (e.g., becomes more negative) and converges toward a maximum value of 100 as the mean ground sidelobes level increases (e.g., becomes less negative).

It is noted that the relationship between the mean ground sidelobes level and the ground sidelobe metric of FIG. 2 is a non-limiting example. Other relationships may be defined between the mean ground sidelobes level and the ground sidelobe metric. In an aspect, the relationship defined between the mean ground sidelobes level and the ground sidelobe metric is generally dependent on application. For example, in the relationship of FIG. 2, a mean ground sidelobe level range of −30 dB to −20 dB spans a wide range of values of the ground sidelobe metric. In another relationship, a mean ground sidelobe level range of −30 dB to −20 dB may span a smaller range of values of the ground sidelobe metric for example.

Graphs that provide correspondences between other characteristics (e.g., half-power azimuth beamwidth, half-power elevation beamwidth, level of sidelobes in the entire field of view (excluding the ground plane)) and associated metrics may also be defined/generated. Although in FIG. 2 the metric's value spans from 0 to 100 and is continuous (e.g., spanning any real number between 0 and 100), the metric's value may span other ranges and/or may be discrete (e.g., spanning only integer values between 0 and 100). A granularity with which a characteristic (e.g., a mean ground sidelobes level) maps to a value of a metric may depend on application, computational time, computational capability, and/or other considerations.

An optimization process may be performed to determine an array pattern that provides desirable behavior. In some embodiments, the optimization process involves determining a position of each antenna element in a staggered antenna array pattern. In some cases, the score associated with the antenna pattern may be used as an indication of whether the array pattern provides desirable behavior, since the score is based on various metrics (e.g., half-power elevation beamwidth, ability to reduce an impact of multi-path effects and/or interference, etc.) of the array pattern. The metrics may be determined for a simulated antenna array or a physical antenna array. In some cases, the optimization process may initially involve simulated antenna arrays, with only a last iteration or a last few iterations involving a physical antenna array.

A comparison of the score of the array pattern with a threshold score may be performed to determine whether the array pattern provides desirable behavior. In some aspects, each metric can be constructed in a way such that a lower value for the metric is associated with a more desirable behavior and thus the optimization process may aim to minimize the score in order to obtain the set of most desirable characteristics of the array pattern. In some aspects, each metric can be constructed in a way such that a higher value for the metric is associated with a more desirable behavior and thus the optimization process may aim to maximize the score in order to obtain the set of most desirable characteristics of the array pattern.

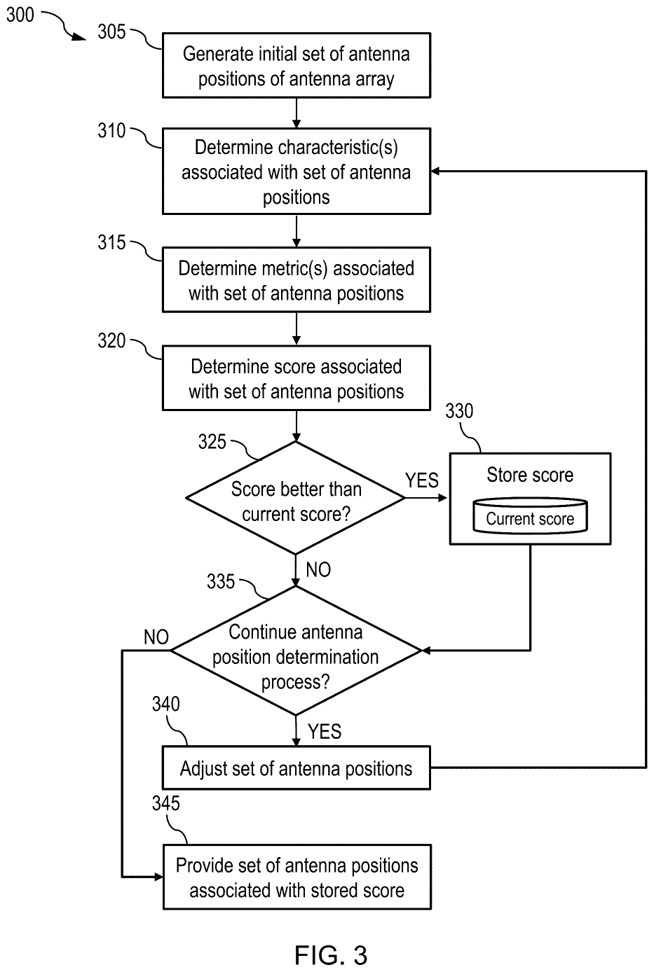

FIG. 3 illustrates a flow diagram of an example process 300 for positioning (e.g., iteratively positioning) antenna elements of an antenna array in accordance with one or more embodiments of the present disclosure. In some embodiments, the antenna array includes a single line of antenna elements. For explanatory purposes, the process 300 is primarily described herein with reference to the system 100 of FIG. 1A; however, the example process 300 is not limited to the system 100. It should be appreciated that any step, sub-step, sub-process, or block of process 300 may be performed in an order or arrangement different from the embodiments illustrated by FIG. 3. In other embodiments, one or more blocks may be omitted from or added to the process 300.

At block 305, the logic device 130 of the radar system 105 or the logic device 185 of the computing system 175 determines an initial set of antenna positions of an antenna array. Each antenna is associated with an antenna position. In some cases, an antenna position may be defined by a position of the antenna element along a first axis/dimension and a position of the antenna element along a second axis/dimension. In some aspects, the initial set of antenna positions may be based, at least in part, on user input. The user input may include data indicative of a desired/intended application of the radar array whose antenna positions are to be optimized and/or desired characteristics/metrics of the radar array. In some cases, the user input may identify the desired/intended application of the radar array, and the logic device 130 or the logic device 185 may determine desired metrics associated with the application and/or retrieve the desired metrics associated with the application (e.g., from a table that associates applications with their respective metrics). In some implementations, the user may be provided with an opportunity to fine tune the metrics. Block 305 may be considered a start of an antenna position determination process (e.g., also referred to as an antenna position optimization process).

In an aspect, the radar system 105 may include an array having multiple columns and multiple rows of antenna elements, and the logic device 130 may selectively activate the antenna elements associated with the initial set of antenna positions. The logic device 130 may then change which of the antenna elements are activated and deactivated in subsequent blocks of the process 300, as further described herein. In an aspect, the logic device 185 may be used to design and test a fixed pattern array having antenna elements only at this initial set of antenna positions. The logic device 185 may then change the design to adjust the positions of the antenna elements in subsequent blocks of the process 300 as further described herein.

At block 310, the logic device 130 or the logic device 185 determines one or more characteristics associated with the set of antenna positions. In some embodiments, the characteristics may include half-power azimuth beamwidth, half-power elevation beamwidth, level of ground sidelobes, level of sidelobes in the entire field of view (excluding the ground plane), ability to reduce/mitigate an impact of interference and/or multi-path effects with the ground or other objects, ability to model and remove the interference and/or multi-path effects with the ground or other objects, and/or other characteristics. In some cases, the characteristics may be determined by running a simulation (e.g., using Matlab and/or other design tool) on a design with an arrangement of antenna elements according to the set of antenna positions associated with each iteration of the antenna position optimization process, with only a last iteration or a last few iterations involving determining characteristics for a physically constructed antenna array.

At block 315, the logic device 130 or the logic device 185 determines a metric associated with the set of antenna positions for each characteristic determined at block 310. In some cases, the metrics may provide an indication of a difference between a value of a characteristic (e.g., a level of ground sidelobe) determined at block 310 and a desired value of the characteristic (e.g., a level of ground sidelobe to be exhibited in the final antenna array design to meet minimum requirements). FIG. 2 provides an example relationship between a mean ground sidelobes level and a ground sidelobe metric.

At block 320, the logic device 130 or the logic device 185 determines a score associated with the set of antenna positions of the antenna array. The score may be based on a combination (e.g., linear combination, non-linear combination) of metrics. For this combination, each metric may be associated with a weight. In some cases, higher weights may be applied to higher priority characteristics/metrics. For example, in some applications, a level of ground sidelobes may be of higher priority than a half-power azimuth beamwidth. In this example, a larger weight (e.g., corresponding to a larger influence when determining a score) may be applied to the level of ground sidelobes than the half-power azimuth beamwidth associated with the antenna array. In some aspects, each metric can be constructed in a way such that a lower value for the metric is associated with a more desirable behavior. In such aspects, a lower score is considered better than a higher score, and the process 300 may aim to obtain a set of antenna positions to minimize the score. In other aspects, each metric can be constructed in a way such that a higher value for the metric is associated with a more desirable behavior. In such aspects, a higher score is considered better than a lower score, and the process 300 may aim to obtain a set of antenna positions to maximize the score.

At block 325, the logic device 130 or the logic device 185 determines whether the score is a better score than a currently stored score by comparing the score to the currently stored score. In this regard, the logic device 130 or the logic device 185 is determining whether the score determined at block 320 is a best score so far in the antenna position optimization process. In some cases, the currently stored score may be stored in the memory 125 or the memory 180 when the process 300 is implemented by the logic device 130 or the logic device 185, respectively. In some cases, during an initial iteration in which the initial set of antenna positions is used, the score may be stored by default (e.g., if there are no other scores to provide a basis for comparison) and serve as a basis for comparison for one or more subsequently determined scores (e.g., until it is replaced by a better score).

If the logic device 130 or the logic device 185 determines at block 325 that the score is better than the currently stored score, the process 300 proceeds from block 325 to block 330. At block 330, the logic device 130 or the logic device 185 stores the score (e.g., in the memory 125 or the memory 180, respectively) such that this score is the best score so far in the antenna position optimization process. In this regard, the score becomes the currently stored score after block 330. In some cases, at block 330, the score may be stored such that it replaces/overwrites the currently stored score. In other cases, multiple scores may be stored simultaneously. For example, multiple scores may be stored along with an indication of the respective set of antenna positions associated with each score (e.g., to facilitate analysis and/or troubleshooting of the antenna position determining process as needed/desired). The process 300 then proceeds from block 330 to block 335. If the logic device 130 or the logic device 185 determines at block 325 that the score is not better than the currently stored score, the process 300 proceeds from block 325 to block 335.

At block 335, the logic device 130 or the logic device 185 determines whether to continue the antenna position determination process. The logic device 130 or the logic device 185 may make the determination based on whether one or more criteria (e.g., one or more termination criteria) have been satisfied. As one example, a criterion may be based on the currently stored score relative to a threshold score. In some cases, when a lower score is considered better than a higher score, the criterion may be whether the currently stored score is below a threshold score and the determination made to end the antenna position determination process when the stored score is below the threshold score. In these cases, a score below the threshold score is a better score than the threshold score. In other cases, when a higher score is considered better than a lower score, the criterion may be whether the currently stored score is above a threshold score and the determination made to end the antenna position determination process when the stored score is above the threshold score. In these cases, a score above the threshold score is a better score than the threshold score. As another example, a criterion may be based on a number of iterations (e.g., times the antenna positions have been adjusted). In some cases, when the number of iterations has not exceeded a threshold number (e.g., and the score is not better than the threshold score), the antenna position determination process continues and the process 300 proceeds from block 335 to block 340. When the number of iterations has exceeded the threshold number, the antenna position determination process ends and the process 300 proceeds from block 335 to block 345.

If the logic device 130 or the logic device 185 determines at block 335 to continue the antenna position determination process, the process 300 proceeds from block 335 to block 340. At block 340, the logic device 130 or the logic device 185 determines adjusts the set of antenna positions to obtain a next set of antenna positions. In an aspect, the logic device 130 may adjust the set of antenna positions by changing which of the antenna elements are activated and deactivated. The set of antenna positions may be updated using one or more processes/algorithms such as, by way of non-limiting examples, gradient descent, simulating annealing, particle swarm optimization, genetic, and/or others. In this regard, the process/algorithm may adjust antenna positions of one or more antenna elements in a manner such that a score associated with this next set of antenna positions is generally better than the score determined at block 320 for the current set of antenna positions or the current stored score. In some cases, when a global score function is a complex multi-dimensional shape, the chosen process/algorithm avoids local minima.

In an aspect, the blocks 310, 315, 320, 325, 330, 335, and/or 340 may be repeated until the score is better than the threshold score (e.g., lower or higher than the threshold score dependent on how the metrics and/or the scores are constructed). In another aspect, the blocks 310, 315, 320, 325, 330, 335, and/or 340 may be repeated until the score is better than the threshold score or until a threshold number of iterations is exceeded (e.g., signifying that the design of the antenna system might not be converging or might not be converging fast enough to the threshold score). In some cases, to reduce the number of degrees of freedom, a subset of antenna element positions may be adjustable, whereas other antenna element positions may be fixed. An antenna position of a given antenna element may be adjustable or considered to be fixed (e.g., after a certain number of iterations in some cases) based on considerations such as individual antenna element radiation, design cost, and/or other considerations.

At block 345, the logic device 130 or the logic device 185 provides the set of antenna positions associated with the stored score. In an aspect, this stored score is the best score and thus the corresponding set of antenna positions is the set of antenna positions determined to have the most desirable behavior among the different sets of antenna positions evaluated during the antenna position determination process. With this set of antenna positions, the antenna array with antenna elements arranged according to this set of antenna positions may be physically constructed (e.g., if not already physically constructed during the process 300).

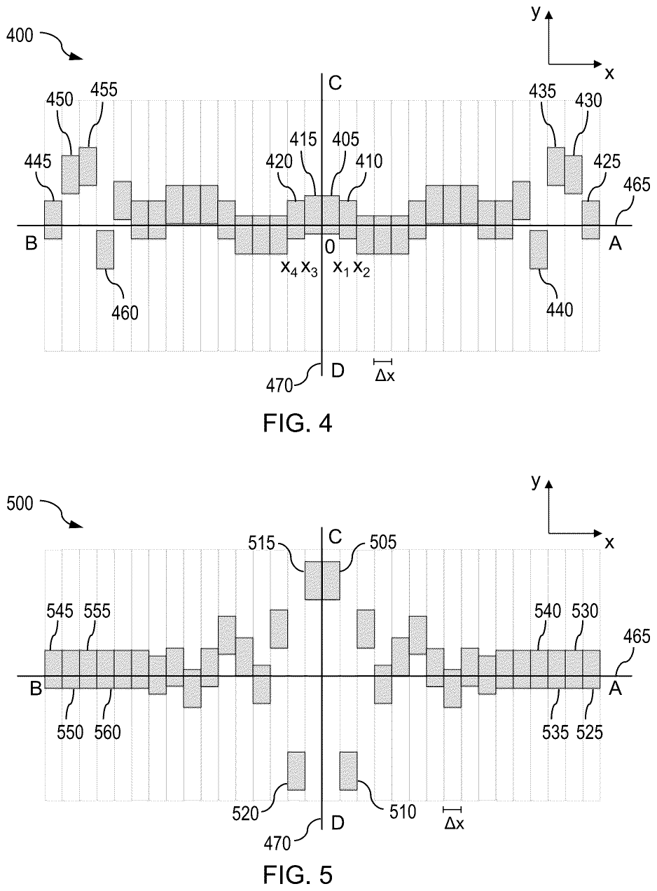

FIGS. 4 through 11 illustrate example staggered antenna arrays in accordance with one or more embodiments of the present disclosure. In some embodiments, FIGS. 4 through 11 may each be associated with a respective antenna position determination process and be an end result (e.g., the best scoring antenna array) of the respective antenna position determination process. Turning first to FIG. 4, FIG. 4 illustrates an example antenna array with thirty-two antenna elements in a substantially symmetrical staggered arrangement in accordance with one or more embodiments of the present disclosure. As shown in FIG. 4, a staggered antenna array 400 includes antenna elements 405, 410, 415, 420, 425, 430, 435, 440, 445, 450, 455, 460, and twenty unlabeled antenna elements. A center (e.g., also referred to as an origin) is defined as an intersection of a horizontal reference axis 465 that extends parallel to an x-direction and a vertical reference axis 470 that extends parallel to a y-direction. It is noted that the center is arbitrary and used to provide a reference position. Characteristics and associated metrics are based on positions of the antenna elements relative to each other. Further in this regard, although the present disclosure provides certain illustrations and description of horizontal and vertical axes, horizontal and vertical axes can be inverted to suit different applications.

In FIG. 4, the staggered antenna array 400 is shown on a grid spanning an x-value along the horizontal axis 465 from B to A and spanning a y-value along the vertical axis 470 from D to C. The antenna elements of the staggered antenna array 400 are spaced apart by a distance Δx. In this regard, the antenna element 405 extends between around x=0 and around x=x₁=Δx, the antenna element 410 extends between around x=x₁ and around x=x₂=2Δx, the antenna element 415 extends between around x=0 and around x=x₃=−Δx. As one non-limiting example, the distance Δx spans around 0.5 operating wavelengths, also denoted as 0.5λ, such that A=8λ and B=−8λ. The grid of FIG. 4 may span a y-value of several operating wavelengths, such as around 10λ to around 20λ. As a non-limiting example, the y-value may span 12λ, such that C=6λ and D=−6λ.

In FIGS. 4 through 11, a lateral height (e.g., dimension along the x-direction) of each antenna element is around the same as the spacing Δx (e.g., around 0.5λ). In other cases, the lateral height may be smaller than the spacing Δx. Although antenna elements in FIGS. 4 through 11 are shown as rectangular in shape, other shapes for antenna elements may be used, including circular, elliptical, triangular, and/or other symmetric, asymmetric, bisymmetric, or otherwise spatially distributed and/or oriented shapes.

Since each Δx spacing (e.g., x between 0 and x₁, x₁ and x₂, etc.) along the x-direction only contains one antenna element, the antenna elements of the staggered antenna array 400 may be referred to as being within a single line. In an aspect, the staggered antenna array 400 may be considered a 1 row×32 column array of antenna elements (e.g., a line is a row) or inverted as a 32 row×1 column array of antenna elements (e.g., a line is a column) to suit different applications. In an aspect, a staggered antenna array within/along a single line may be referred to as a linear staggered antenna array or a single-line staggered antenna array. Adjacent (or neighboring) antenna elements of an antenna array may refer to antenna elements that are closest to one another (e.g., around Δx apart from each other). As examples, the antenna element 405 is adjacent to the antenna elements 410 and 415, and the antenna element 445 is adjacent to the antenna element 450. In some aspects, since each horizontal spacing is discrete and contains within it a single antenna element, placement of a given antenna element within each horizontal spacing may be referred to as vertical placement (e.g., a position along the y-direction) of the antenna element. In this regard, in these aspects, the process 300 of FIG. 3 may be considered to determine vertical antenna positions of antenna elements.

The staggered antenna array 400 is substantially symmetric about the vertical reference axis 470. The antenna elements of the staggered antenna array 400 fluctuate about the horizontal reference axis 465 such that adjacent antenna elements farther from the center (e.g., the antenna elements 425, 430, 435, 440 and 445, 450, 455, 460) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 405, 410, 415, and 420). In some cases, the fluctuation may be described as a substantially sinusoidal fluctuation whose amplitude increases for antenna elements of the array 400 farther from the center relative to antenna elements of the array 400 closer to the center.

In an aspect, a vertical distance from the horizontal axis 465 may be measured based on a center (or centroid in three-dimensional space) of each antenna element along the vertical direction to the horizontal axis 465. It is noted that use of the center of each antenna element is arbitrary and any portion of the antenna element (e.g., top-edge, bottom-edge, or anywhere in between) may be used so long as the same portion is consistently used for the antenna elements to determine the vertical distance. With reference to the above non-limiting example with C=6λ and D=−6λ, the antenna elements 405 and 415 may have a vertical distance of around/approximately 0.5λ from the horizontal axis 465, the antenna elements 410 and 420 may have a vertical distance of around/approximately 0.25λ from the horizontal axis 465, the antenna elements 440 and 460 may have a vertical distance of around/approximately −1λ from the horizontal axis 465, the antenna elements 435 and 455 may have a vertical distance of around/approximately 3λ from the horizontal axis 465, the antenna elements 430 and 450 may have a vertical distance of around/approximately 2.75λ from the horizontal axis 465, and the antenna elements 425 and 445 may have a vertical distance of around/approximately 0.25λ from the horizontal axis 465. In this regard, in FIG. 4, adjacent antenna elements may have, as non-limiting examples, the same vertical distance, such as the antenna elements 405 and 415, similar vertical distance, such as the antenna elements 405 and 410 or 415 and 420, and widely varying vertical distance, such as the antenna elements 455 and 460 which have a difference in vertical distance of around/approximately 4λ.

FIG. 5 illustrates another example antenna array with thirty-two antenna elements in a substantially symmetrical staggered arrangement in accordance with one or more embodiments of the present disclosure. The description of FIG. 4 generally applies to FIG. 5, with examples of differences between FIGS. 4 and 5 and other description provided herein. A staggered antenna array 500 includes antenna elements 505, 510, 515, 520, 525, 530, 535, 540, 545, 550, 555, 560, and twenty unlabeled antenna elements. The staggered antenna array 500 is substantially symmetric about the vertical reference axis 470. The antenna elements of the staggered antenna array 500 fluctuate about the horizontal reference axis 465 such that adjacent antenna elements farther from the center (e.g., the antenna elements 525, 530, 535, and 540 and 545, 550, 555, and 560) have an average distance along the y-direction (e.g., the vertical direction) from the horizontal reference axis 465 that is smaller than an average distance along the y-direction from the horizontal reference axis 465 for adjacent antenna elements closer to the center (e.g., the antenna elements 505, 510, 515, and 520). In some cases, the fluctuation may be described as a substantially sinusoidal fluctuation whose amplitude decreases for antenna elements of the array 500 farther from the center relative to antenna elements of the array 500 closer to the center.

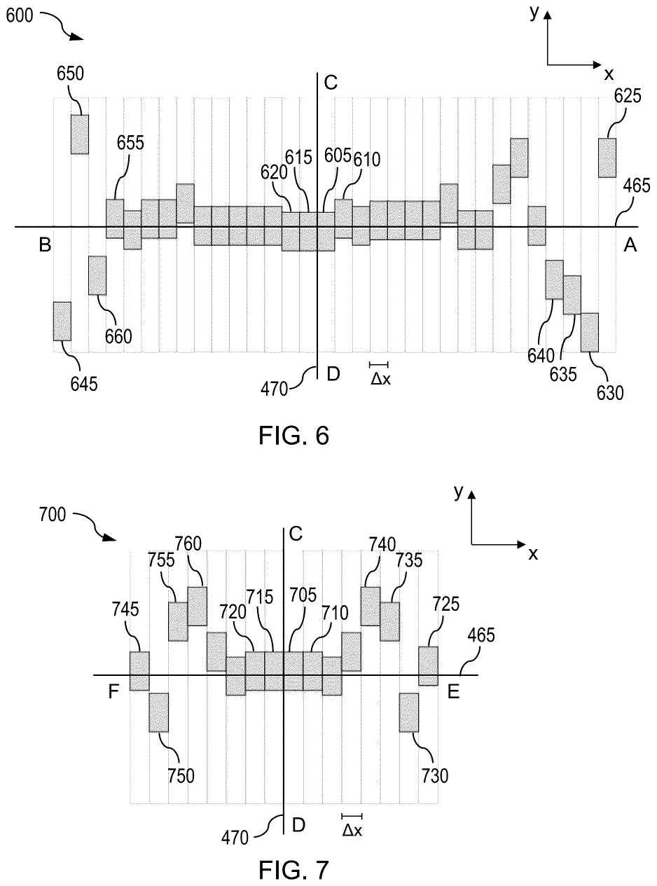

With reference to the above non-limiting example with C=6λ and D=−6λ, the antenna elements 505 and 515 may have a vertical distance of around/approximately 4.5λ from the horizontal axis 465, the antenna elements 510 and 520 may have a vertical distance of around/approximately −4.5λ from the horizontal axis 465, and the antenna elements 525, 530, 535, 535, 545, 550, 555, and 560 may have a vertical distance of around/approximately 0.5λ from the horizontal axis 465. In this regard, in FIG. 5, adjacent antenna elements may have the same vertical distance, such as the antenna elements 525, 530, 535, 535, 545, 550, 555, and 560, and widely varying vertical distance, such as the antenna elements 505 and 510 and the antenna elements 515 and 520, which have a difference in vertical distance of around/approximately 9λ, as well as unlabeled adjacent antenna elements shown in FIG. 5. In FIG. 5, adjacent antenna elements may have vertical positions that differ from each other by anywhere from approximately 0 to 9λ as well as vertical distances in between (e.g., 7λ, 3λ, 1λ, less than 1λ, etc.). Examples of vertical distances in FIGS. 4 and 5 generally also apply to FIGS. 6 through 11.

FIG. 6 illustrates an example antenna array with thirty-two antenna elements in an asymmetrical staggered arrangement in accordance with one or more embodiments of the present disclosure. The description of FIGS. 4-5 generally applies to FIG. 6, with examples of differences between FIGS. 4-5 and FIG. 6 and other description provided herein. A staggered antenna array 600 includes antenna elements 605, 610, 615, 620, 625, 630, 635, 640, 645, 650, 655, 660, and twenty unlabeled antenna elements. The staggered antenna array 600 is asymmetric about the vertical reference axis 470. The antenna elements of the staggered antenna array 600 fluctuate about the horizontal reference axis 465 such that adjacent antenna elements farther from the center (e.g., the antenna elements 625, 630, 635, and 640 and 645, 650, 655, and 660) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 605, 610, 615, and 620). In some cases, the fluctuation may be described as a fluctuation whose amplitude increases for antenna elements of the array 600 farther from the center relative to antenna elements of the array 600 closer to the center.

FIG. 7 illustrates an example antenna array with sixteen antenna elements in a substantially symmetrical staggered arrangement in accordance with one or more embodiments of the present disclosure. The description of FIGS. 4-6 generally applies to FIG. 7, with examples of differences between FIGS. 4-6 and FIG. 7 and other description provided herein. A staggered antenna array 700 includes antenna elements 705, 710, 715, 720, 725, 730, 735, 740, 745, 750, 755, 760, and four unlabeled antenna elements. The staggered antenna array 700 is substantially symmetric about the vertical reference axis 470. The antenna elements of the staggered antenna array 700 fluctuate about the horizontal reference axis 465 such that adjacent antenna elements farther from the center (e.g., the antenna elements 725, 730, 735, and 740 and 745, 750, 755, and 760) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 705, 710, 715, and 720). In some cases, the fluctuation may be described as a fluctuation whose amplitude increases for antenna elements of the array 700 farther from the center relative to antenna elements of the array 700 closer to the center. As one non-limiting example, the distance Δx spans around 0.5 operating wavelengths, also denoted as 0.5λ, such that E=4λ and F=−4λ.

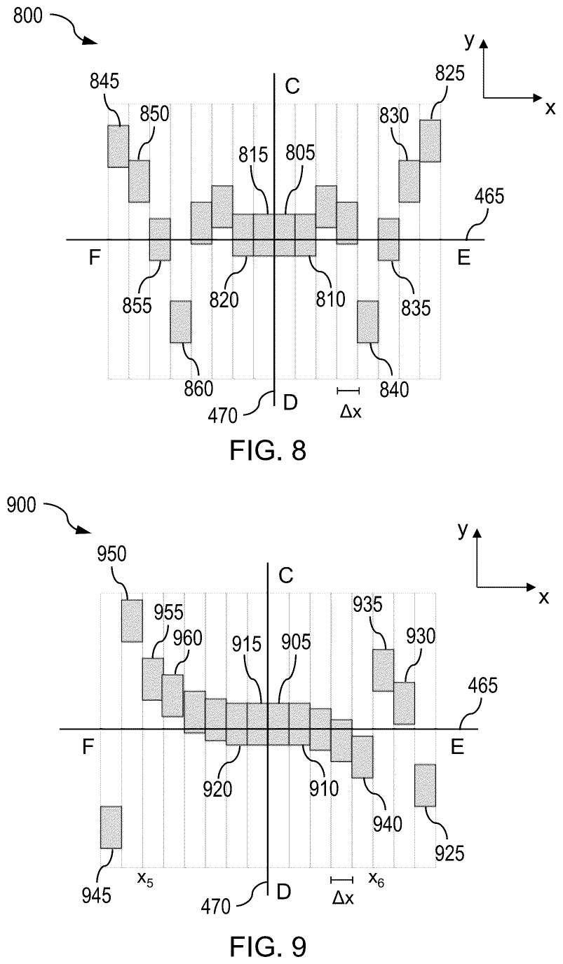

FIG. 8 illustrates another example antenna array with sixteen antenna elements in a substantially symmetrical staggered arrangement in accordance with one or more embodiments of the present disclosure. The description of FIGS. 4-7 generally applies to FIG. 8, with examples of differences between FIGS. 4-7 and FIG. 8 and other description provided herein. A staggered antenna array 800 includes antenna elements 805, 810, 815, 820, 825, 830, 835, 840, 845, 850, 855, 860, and four unlabeled antenna elements. The staggered antenna array 800 is substantially symmetric about the vertical reference axis 470. The antenna elements of the staggered antenna array 800 fluctuate about the horizontal reference axis 465 such that adjacent antenna elements farther from the center (e.g., the antenna elements 825, 830, 835, and 840 and 845, 850, 855, and 860) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 805, 810, 815, and 820). In some cases, the fluctuation may be described as a fluctuation whose amplitude increases for antenna elements of the array 800 farther from the center relative to antenna elements of the array 800 closer to the center.

FIG. 9 illustrates an example antenna array with sixteen antenna elements in an asymmetrical staggered arrangement in accordance with one or more embodiments of the present disclosure. The description of FIGS. 4-8 generally applies to FIG. 9, with examples of differences between FIGS. 4-8 and FIG. 9 and other description provided herein. A staggered antenna array 900 includes antenna elements 905, 910, 915, 920, 925, 930, 935, 940, 945, 950, 955, 960, and four unlabeled antenna elements. The staggered antenna array 900 is asymmetric about the vertical reference axis 470. The antenna elements of the staggered antenna array 900 fluctuate about the horizontal reference axis 465 such that adjacent antenna elements farther from the center (e.g., the antenna elements 925, 930, 935, and 940 and 945, 950, 955, and 960) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 905, 910, 915, and 920). From about x₅ to about x₆, the antenna elements close to the center have a small distance/offset from the horizontal reference axis 465. This distance/offset of the antenna elements from the horizontal reference axis 465 increases at a fast rate as distance from the center increases and then starts to cross (e.g., be disposed on opposite sides of) the horizontal reference axis 465.

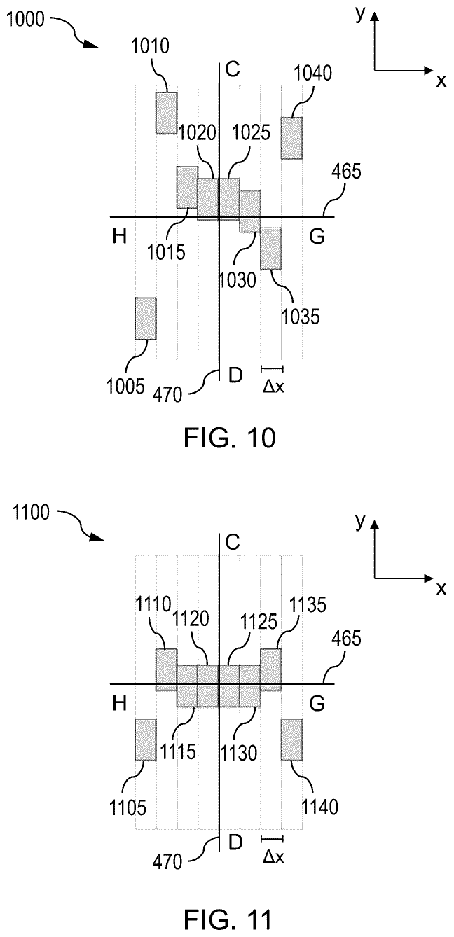

FIG. 10 illustrates an example antenna array with eight antenna elements in an asymmetrical staggered arrangement in accordance with one or more embodiments of the present disclosure. The description of FIGS. 4-9 generally applies to FIG. 10, with examples of differences between FIGS. 4-9 and FIG. 10 and other description provided herein. A staggered antenna array 1000 includes antenna elements 1005, 1010, 1015, 1020, 1025, 1030, 1035, and 1040. The staggered antenna array 1000 is asymmetric about the vertical reference axis 470. The antenna elements of the staggered antenna array 1000 fluctuate about the horizontal reference axis 465 such that adjacent antenna elements farther from the center (e.g., the antenna elements 1005, 1010, 1015, 1035, and 1040) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 1020 and 1025). The antenna elements close to the center have a small distance/offset from the horizontal reference axis 465. This distance/offset of the antenna elements from the horizontal reference axis 465 increases at a fast rate as distance from the center increases and then starts to cross the horizontal reference axis 465. As one non-limiting example, the distance Δx spans around 0.5 operating wavelengths, also denoted as 0.5λ, such that G=2λ and H=−2λ.

FIG. 11 illustrates an example antenna array with eight antenna elements in a substantially symmetrical staggered arrangement in accordance with one or more embodiments of the present disclosure. The description of FIGS. 4-10 generally applies to FIG. 11, with examples of differences between FIGS. 4-10 and FIG. 11 and other description provided herein. A staggered antenna array 1100 includes antenna elements 1105, 1110, 1115, 1120, 1125, 1130, 1135, and 1140. The staggered antenna array 1100 is substantially symmetric about the vertical reference axis 470. The antenna elements of the staggered antenna array 1100 fluctuate about the horizontal reference axis 465 such that adjacent antenna elements farther from the center (e.g., the antenna elements 1105, 1110, 1135, and 1140) have an average distance along the y-direction (e.g., the vertical direction) from the horizontal reference axis 465 that is larger than an average distance along the y-direction from the horizontal reference axis 465 for adjacent antenna elements closer to the center (e.g., the antenna elements 1115, 1120, 1125, and 1130). The antenna elements close to the center have a small distance/offset from the horizontal reference axis 465.

Examples are shown for eight, sixteen, and thirty-two antenna elements, but any other number (e.g., even or odd) of antenna elements can be used. In an aspect, a center of a single line of antenna elements divides the single line of antenna elements into two subsets of antenna elements having the same number of antenna elements. As an example, for thirty-two antenna elements, the center divides the line of thirty-two antenna elements into two subsets of sixteen antenna elements. As an example, for thirty-three antenna elements, the center divides the line of thirty-three antenna elements into two subsets of 16.5 antenna elements or, equivalently/alternatively, two subsets of sixteen antenna elements plus a lone antenna element. This center of the single line is at an intersection of the horizontal reference axis 465 and the vertical reference axis 470. In general, a higher number of antenna elements allows for more degrees of freedom for an optimization process to determine a position of each antenna element to provide an antenna array associated with a desired score. In some embodiments, the antenna elements of FIGS. 4 through 11 may be used as receive antenna elements. In other embodiments, alternatively or in addition, the antenna elements of FIGS. 4 through 11 may be used as transmitter antenna elements or transceiver antenna elements.

In some embodiments, with reference to the example process 300 of FIG. 3 and the example staggered antenna arrays of FIGS. 4 through 11, each staggered antenna array of FIGS. 4 through 11 may be obtained by performing the process 300 to iteratively adjust a position of the antenna elements. In some aspects, for symmetrical (or substantially or nominally symmetrical) arrays, the process 300 may iteratively adjust positions of each corresponding pairs of antenna elements and, if the array has an odd number of antenna elements, a position of an additional lone antenna element. In some embodiments, the process 300 may be performed to optimize/determine the vertical placement of a set of antenna elements, as shown in FIGS. 4 through 11, in such a way as to simultaneously optimize several performance figures/characteristics, such as by way of non-limiting examples: level of ground sidelobes, level of sidelobes in the entire field of view, azimuth/elevation accuracies, ability to mitigate/reduce interference and/or multi-path effects with the ground or other objects, width of the beam in the azimuth plane, beamformed response (e.g., two-dimensional beamformed response), etc. Since the set of antenna elements is along a line, the set of antenna elements may be referred to as a linear set of antenna elements. The vertical placement of the antenna elements may, but need not, possess a symmetry on the horizontal axis, depending on the desired characteristics.

As shown for example in FIGS. 4 through 11, adjacent antenna elements may have the same vertical distance or substantially the same vertical distance (e.g., 605, 610, 615, and 620 in FIGS. 6; 805, 810, 815, and 820 in FIG. 8, etc.) and, within the same staggered antenna array in some cases, adjacent antenna elements may have widely varying vertical distances (e.g., 505 and 510 have a vertical distance between them of approximately 9λ). As non-limiting examples, antenna elements may have vertical distances approximately between −5λ to −3λ from the horizontal axis 465 (e.g., 510 and 520 in FIG. 5; 945 in FIG. 9) or approximately between +3λ and +5λ from the horizontal axis 465 (e.g., 505 and 515 in FIG. 5; 950 in FIG. 9), and adjacent antenna elements may have large differences in vertical distances approximately between −10λ to −5λ or between +5λ to +10λ. Vertical distances for antenna elements relative to the horizontal axis 465 and vertical distances between adjacent antenna elements may exhibit various ranges as appropriate to achieve desired characteristics, as shown for example in FIGS. 4 through 11.

Using various embodiments, optimizing the position of the antenna elements in the vertical plane may simultaneously allow two-dimensional beamforming, achieving sufficient accuracy on both the azimuth and elevation angles, obtaining low sidelobes at the ground level, reducing (e.g., considerably reducing) azimuth and/or elevation errors caused by multi-path effects with external objects, the ground, or the environment or other type of external interference, and so forth. In some embodiments, as set forth above, for a given antenna array, performance metrics may be determined based on the performance figures and, in turn, a score associated with the antenna array may be determined based on the performance metrics (e.g., a weighted combination of the metrics). In some cases, the optimization process may be performed in such a way that all desired performance characteristics are considered simultaneously at optimization time to provide better performance characteristics, such as better angular accuracies, while using fewer antenna elements (e.g., fewer receive antenna elements) than conventional approaches with multiple rows and multiple columns of antenna elements.

Although various embodiments are described primarily with reference to antennas and antenna arrays for radar systems for transmitting and/or receiving electromagnetic waves, one or more embodiments may also apply alternatively or in addition to antennas and antenna arrays used in sonar systems (e.g., for transmitting and/or receiving sound waves), lidar systems (e.g., for transmitting and/or receiving light pulses), and/or generally any systems in which detection and/or ranging may be desired. In this regard, in some embodiments, the process 300 may be used to place antenna elements of radar systems, sonar systems, lidar systems, etc. and/or one or more of the staggered antenna arrays of FIGS. 4 through 11 may be used in radar systems, sonar systems, lidar systems, etc.

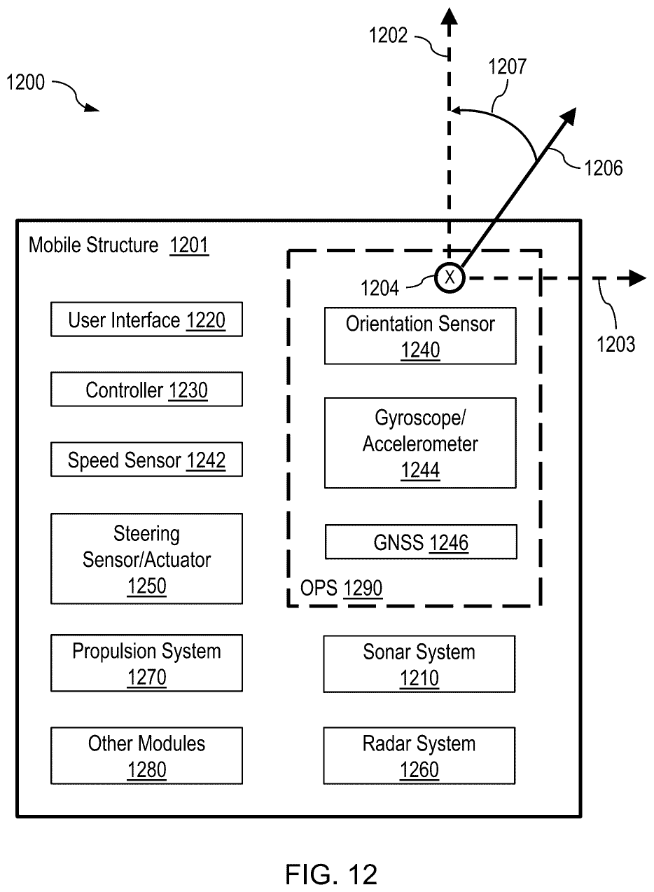

FIG. 12 illustrates a block diagram of a ranging system 1200 in accordance with one or more embodiments of the present disclosure. In various embodiments, the ranging system 1200 may be configured to detect a target and/or determine a range to a target using a sonar system 1210, a radar system 1260, and/or other types of ranging systems. In this regard, the sonar system 1210 and/or the radar system 1260 may be configured to transmit a ranging system signal (e.g., a pulse or beam or a series of pulses/pulse train) towards a target and receive at least a portion of the transmitted signal reflected from the target as a ranging signal return. The system 1200 may then process the ranging signal return to de-convolve the target (e.g., identify, separate, or reconstruct a signal indicative of the return reflected from the target and/or a direction corresponding to the relative position of the target).

In some embodiments, the system 1200 may be configured to measure an orientation, a position, an acceleration, and/or a speed of the sonar system 1210, radar system 1260, user interface 1220, and/or mobile structure 1201 using any of the various sensors of OPS 1290 and/or the system 1200. The system 1200 may then use these measurements to generate accurate image data, detect and track moving objects (e.g., targets) and generate/maintain a list(s) of tracks and their characteristics, and/or generate other results dependent on application from ranging data provided by the sonar system 1210, the radar system 1260, and/or other ranging systems or types of ranging systems (e.g., other modules 1280), according to a desired operation of the system 1200 and/or the mobile structure 1201. In some embodiments, the system 1200 may display resulting imagery, detection and tracking results, etc. to a user through the user interface 1220, and/or use the sonar data, radar data, orientation and/or sensor data, and/or imagery to control operation of the mobile structure 1201, such as controlling a steering actuator 1250 and/or a propulsion system 1270 to steer the mobile structure 1201 according to a desired heading, such as a heading angle 1207, for example.

In the embodiment shown in FIG. 12, the system 1200 may be implemented to provide ranging data and/or imagery for a particular type of the mobile structure 1201, such as a drone, a watercraft, an aircraft, a robot, a vehicle, and/or other types of mobile structures, including any platform designed to move through or under the water, through the air, and/or on a terrestrial surface. In one embodiment, the system 1200 may include one or more of a sonar system 1210, a radar system 1260, a user interface 1220, a controller 1230, an OPS 1290 (e.g., including an orientation sensor 1240, a gyroscope/accelerometer 1244, and/or a global navigation satellite system (GNSS) 1246), a speed sensor 1242, a steering sensor/actuator 1250, a propulsion system 1270, and one or more other sensors and/or actuators, such as other modules 1280. In some embodiments, one or more of the elements of the system 1200 may be implemented in a combined housing or structure that can be coupled to the mobile structure 1201 and/or held or carried by a user of the mobile structure 1201.

Directions 1202, 1203, and 1204 describe one possible coordinate frame of the mobile structure 1201 (e.g., for headings or orientations measured by the orientation sensor 1240 and/or angular velocities and accelerations measured by the gyroscope 1244 and the accelerometer 1245). As shown in FIG. 12, the direction 1202 illustrates a direction that may be substantially parallel to and/or aligned with a longitudinal axis of the mobile structure 1201, the direction 1203 illustrates a direction that may be substantially parallel to and/or aligned with a lateral axis of the mobile structure 1201, and the direction 1204 illustrates a direction that may be substantially parallel to and/or aligned with a vertical axis of the mobile structure 1201, as described herein. For example, a roll component of motion of the mobile structure 1201 may correspond to rotations around the direction 1202, a pitch component may correspond to rotations around the direction 1203, and a yaw component may correspond to rotations around the direction 1204.

The heading angle 1207 may correspond to the angle between a projection of a reference direction 1206 (e.g., the local component of the Earth's magnetic field) onto a horizontal plane (e.g., referenced to a gravitationally defined “down” vector local to the mobile structure 1201) and a projection of the direction 1202 onto the same horizontal plane. In some embodiments, the projection of the reference direction 1206 onto a horizontal plane (e.g., referenced to a gravitationally defined “down” vector) may be referred to as Magnetic North. In various embodiments, Magnetic North, True North, a “down” vector, and/or various other directions, positions, and/or fixed or relative reference frames may define an absolute coordinate frame, for example, where directional measurements referenced to an absolute coordinate frame may be referred to as absolute directional measurements (e.g., an “absolute” orientation).

In some embodiments, directional measurements may initially be referenced to a coordinate frame of a particular sensor (e.g., a sonar transducer assembly or other module of the sonar system 1210, OPS 1290, orientation sensor 1240, and/or user interface 1220, for example) and be transformed (e.g., using parameters for one or more coordinate frame transformations) to be referenced to an absolute coordinate frame and/or a coordinate frame of the mobile structure 1201. In various embodiments, an absolute coordinate frame may be defined and/or correspond to a coordinate frame with one or more undefined axes, such as a horizontal plane local to the mobile structure 1201 and referenced to a local gravitational vector but with an unreferenced and/or undefined yaw reference (e.g., no reference to Magnetic North).

The sonar system 1210 may be implemented as one or more electrically and/or mechanically coupled controllers, transmitters, receivers, transceivers, signal processing logic devices, various electrical components, transducer elements of various shapes and sizes, multichannel transducers/transducer modules, transducer assemblies, assembly brackets, transom brackets, and/or various actuators adapted to adjust orientations of any of the components of the sonar system 1210, as described herein. The sonar system 1210 may be configured to emit one, multiple, or a series of acoustic beams, receive corresponding acoustic returns, and convert the acoustic returns into sonar data and/or imagery, such as bathymetric data, water depth, water temperature, water column/volume debris, bottom profile, and/or other types of sonar data. The sonar system 1210 may be configured to provide such data and/or imagery to the user interface 1220 for display to a user, for example, or to the controller 1230 for additional processing, as described herein.

For example, in various embodiments, the sonar system 1210 may be implemented and/or operated according to any of the systems and methods described in U.S. Provisional Patent Application 62/005,838 filed May 30, 2014 and entitled “MULTICHANNEL SONAR SYSTEMS AND METHODS”, and/or U.S. Provisional Patent Application 61/943,170 filed Feb. 21, 2014 and entitled “MODULAR SONAR TRANSDUCER ASSEMBLY SYSTEMS AND METHODS”, both of which are hereby incorporated by reference in their entirety. In other embodiments, the sonar system 1210 may be implemented according to other sonar system arrangements that can be used to detect objects within a water column and/or a floor of a body of water.

Although FIG. 12 shows various sensors and/or other components of the system 1200 separate from the sonar system 1210, in other embodiments, any one or combination of sensors and components of the system 1200 may be integrated with a sonar assembly, an actuator, a transducer module, and/or other components of the sonar system 1210. For example, the OPS 1290 may be integrated with a transducer module of the sonar system 1210 and be configured to provide measurements of an absolute and/or relative orientation (e.g., a roll, pitch, and/or yaw) of the transducer module to the controller 1230 and/or the user interface 1220, both of which may also be integrated with the sonar system 1210. In some embodiments, the sonar system 1210 may include an antenna array having antenna elements whose positions are determined according to the process 300.

The radar system 1260 may be implemented as one or more electrically and/or mechanically coupled controllers, transmitters, receivers, transceivers, signal processing logic devices, various electrical components, transducer elements (e.g., antenna elements) of various shapes and sizes, multichannel transducers/transducer modules, radar assemblies, assembly brackets, mast brackets, and/or various actuators adapted to adjust orientations of any of the components of the radar system 1260, as described herein. For example, in various embodiments, the radar system 1260 may be implemented according to various radar system arrangements (e.g., detection and ranging system arrangements) that can be used to detect features of and determine a distance to objects on or above a terrestrial surface or a surface of a body of water. In some embodiments, the radar system 1260 may be, may include, or may be a part of the radar system 105 of FIG. 1A. In some embodiments, the radar system 1260 may include an antenna array having antenna elements whose positions are determined according to the process 300.

More generally, the radar system 1260 may be configured to emit one, multiple, or a series of radar beams (e.g., beamformed or direct ranging sensor pulses having a radio frequency wave as a carrier), receive corresponding radar returns/echoes, and convert the radar returns into radar data and/or imagery (e.g., ranging image data), such as one or more intensity plots and/or aggregation of intensity plots indicating a relative position, orientation, and/or other characteristics of structures, weather phenomena, waves, other mobile structures, surface boundaries, and/or other objects reflecting the radar beams back at the radar system 1260. The radar system 1260 may be configured to provide such data and/or imagery to the user interface 1220 for display to a user, for example, or to the controller 1230 for additional processing, as described herein. Moreover, such data may be used to generate one or more charts corresponding to AIS data, ARPA data, MARPA data, and or one or more other target tracking and/or identification protocols.

In some embodiments, the radar system 1260 may be implemented using a compact design, where multiple radar transducers, sensors, and/or associated processing devices are located within a single radar assembly housing that is configured to interface with the rest of the system 1200 through a single cable providing both power and communications to and from the radar system 1260. In some embodiments, the radar system 1260 may include orientation and/or position sensors (e.g., OPS 1290) configured to help provide two or three dimensional waypoints, increase radar data and/or imagery quality, and/or provide highly accurate radar image data, as described herein.

In various embodiments, the radar system 1260 may be implemented with its own dedicated OPS 1290, which may include various orientation and/or position sensors (e.g., similar to orientation sensor 1240, gyroscope/accelerometer 1244, and/or GNSS 1246) that may be incorporated within the radar assembly housing to provide three dimensional orientations and/or positions of the radar assembly and/or transducer(s) for use when processing or post processing radar data for display. The sensor information can be used to correct for movement of the radar assembly between beam emissions to provide improved alignment of corresponding radar returns/samples, for example, and/or to generate imagery based on the measured orientations and/or positions of the radar assembly/transducer. In other embodiments, an external orientation and/or position sensor can be used alone or in combination with an integrated sensor or sensors.

In embodiments where the radar system 1260 is implemented with a position sensor, the radar system 1260 may be configured to provide a variety of radar data and/or imagery enhancements. For example, the radar system 1260 may be configured to provide accurate positioning of radar returns remote from the mobile system 1201. Similarly, the radar system 1260 may be configured to provide accurate two and/or three dimensional aggregation and/or display of a series of radar data; without either orientation data or position data to help determine a track or heading, a radar system typically assumes a straight track, which can cause image artifacts and/or other inaccuracies in corresponding radar data and/or imagery. Additionally, when implemented with a position sensor, the radar system 1260 may be configured to generate accurate and detailed intensity plots of objects on a surface of a body of water.

In embodiments where the radar system 1260 is implemented with an orientation and/or position sensor, the radar system 1260 may be configured to store such location/position information along with other sensor information (radar returns, temperature measurements, text descriptions, altitude, mobile structure speed, and/or other sensor and/or control information) available to the system 1200. In some embodiments, the controller 1230 may be configured to generate a look up table so that a user can select desired configurations of the radar system 1260 for a particular location or to coordinate with some other sensor information. Alternatively, an automated adjustment algorithm can be used to select optimum configurations based on the sensor information.

For example, in one embodiment, the mobile structure 1201 may be located in an area identified on a chart using position data, a user may have selected a user setting for a configuration of the radar system 1260, and the controller 1230 may be configured to control an actuator and/or otherwise implement the configuration for the radar system 1260 (e.g., to set a particular orientation or rotation rate). In still another embodiment, the controller 1230 may be configured to receive orientation measurements for the mobile structure 1201. In such embodiment, the controller 1230 may be configured to control the actuators associated with the radar assembly to maintain its orientation relative to, for example, the mobile structure 1201 and/or the water surface, and thus improve the displayed radar images (e.g., by ensuring consistently oriented radar beams and/or proper registration of a series of radar returns). In various embodiments, the controller 1230 may be configured to control the steering sensor/actuator 1250 and/or the propulsion system 1270 to adjust a position and/or orientation of the mobile structure 1201 to help ensure proper registration of a series of radar returns, radar data, and/or radar imagery.

Although FIG. 12 shows various sensors and/or other components of the system 1200 separate from the radar system 1260, in other embodiments, any one or combination of sensors and components of the system 1200 may be integrated with a radar assembly, an actuator, a transducer module, and/or other components of the radar system 1260. For example, the OPS 1290 may be integrated with an antenna platform of the sonar system 1210 and be configured to provide measurements of an absolute and/or relative orientation (e.g., a roll, pitch, and/or yaw) of the antenna to the controller 1230 and/or the user interface 1220, both of which may also be integrated with the radar system 1260.

As used herein, the term “transducer” may refer generally to a device configured to convert electrical signals into ranging system transmission signals and to convert ranging system transmission signals into electrical signals, including sonar transducers or transducer elements, radar antennas or antenna elements, and/or other ranging system transmitter and/or sensor/receiver elements.

The user interface 1220 may be implemented as a display, a touch screen, a keyboard, a mouse, a joystick, a knob, a steering wheel, a ship's wheel or helm, a yoke, and/or any other device capable of accepting user input and/or providing feedback to a user. In various embodiments, the user interface 1220 may be adapted to provide user input (e.g., as a type of signal and/or sensor information) to other devices of the system 1200, such as the controller 1230. The user interface 1220 may also be implemented with one or more logic devices that may be adapted to execute instructions, such as software instructions, implementing any of the various processes and/or methods described herein. For example, the user interface 1220 may be adapted to form communication links, transmit and/or receive communications (e.g., sensor signals, control signals, sensor information, user input, and/or other information), determine various coordinate frames and/or orientations, determine parameters for one or more coordinate frame transformations, and/or perform coordinate frame transformations, for example, or to perform various other processes and/or methods.

In various embodiments, the user interface 1220 may be adapted to accept user input, for example, to form a communication link, to select a particular wireless networking protocol and/or parameters for a particular wireless networking protocol and/or wireless link (e.g., a password, an encryption key, a MAC address, a device identification number, a device operation profile, parameters for operation of a device, and/or other parameters), to select a method of processing sensor signals to determine sensor information, to adjust a position and/or orientation of an articulated sensor, and/or to otherwise facilitate operation of the system 1200 and devices within the system 1200. Once the user interface 1220 accepts a user input, the user input may be transmitted to other devices of the system 1200 over one or more communication links.

In one embodiment, the user interface 1220 may be adapted to receive a sensor or control signal (e.g., from the orientation sensor 1240 and/or steering sensor/actuator 1250) over communication links formed by one or more associated logic devices, for example, and display sensor and/or other information corresponding to the received sensor or control signal to a user. In related embodiments, the user interface 1220 may be adapted to process sensor and/or control signals to determine sensor and/or other information. For example, a sensor signal may include an orientation, an angular velocity, an acceleration, a speed, and/or a position of the mobile structure 1201. In such embodiment, the user interface 1220 may be adapted to process the sensor signals to determine sensor information indicating an estimated and/or absolute roll, pitch, and/or yaw (attitude and/or rate), and/or a position or series of positions of the sonar system 1210, radar system 1260, and/or mobile structure 1201, for example, and display the sensor information as feedback to a user.

In one embodiment, the user interface 1220 may be adapted to display a time series of various sensor information and/or other parameters as part of or overlaid on a graph or map, which may be referenced to a position and/or orientation of the mobile structure 1201. For example, the user interface 1220 may be adapted to display a time series of positions, headings, and/or orientations of the mobile structure 1201 and/or other elements of the system 1200 (e.g., a transducer assembly and/or module of the sonar system 1210 or radar system 1260) overlaid on a geographical map, which may include one or more graphs indicating a corresponding time series of actuator control signals, sensor information, and/or other sensor and/or control signals, including sonar, radar, and/or other ranging image data.

In some embodiments, the user interface 1220 may be adapted to accept user input including a user-defined target heading, waypoint, route, and/or orientation for an element of the system 1200, for example, and to generate control signals for the OPS 1290 to cause the mobile structure 1201 to move according to the target heading, waypoint, route, track, and/or orientation. In other embodiments, the user interface 1220 may be adapted to accept user input modifying a control loop parameter of the controller 1230, for example, or selecting a responsiveness of the controller 1230 in controlling a direction (e.g., through application of a particular steering angle) of the mobile structure 1201.

In some embodiments, the user interface 1220 may be adapted to accept user input including a user-defined target heading, route, and/or orientation for a transducer module, for example, and to generate control signals for the steering sensor/actuator 1250 and/or propulsion system 1270 to cause the mobile structure 1201 to move according to the target heading, route, and/or orientation. In further embodiments, the user interface 1220 may be adapted to accept user input including a user-defined target attitude/angular frequency for an actuated device (e.g., sonar system 1210, radar system 1260) coupled to the mobile structure 1201, for example, and to generate control signals for adjusting an orientation or rotation of the actuated device according to the target attitude/angular frequency. More generally, the user interface 1220 may be adapted to display sensor information to a user, for example, and/or to transmit sensor information and/or user input to other user interfaces, sensors, or controllers of the system 1200, for instance, for display and/or further processing. In one embodiment, the user interface 1220 may be integrated with one or more sensors (e.g., imaging modules, position and/or orientation sensors, other sensors) and/or be portable (e.g., such as a portable touch display or smart phone, for example, or a wearable user interface) to facilitate user interaction with various systems of the mobile structure 1201.

The controller 1230 may be implemented as any appropriate logic device (e.g., processing device, microcontroller, processor, application specific integrated circuit (ASIC), field programmable gate array (FPGA), memory storage device, memory reader, or other device or combinations of devices) that may be adapted to execute, store, and/or receive appropriate instructions, such as software instructions implementing a control loop for controlling various operations of the sonar system 1210, radar system 1260, steering sensor/actuator 1250, mobile structure 1201, and/or system 1200, for example. Such software instructions may also implement methods for processing sensor signals, determining sensor information, providing user feedback (e.g., through the user interface 1220), querying devices for operational parameters, selecting operational parameters for devices, or performing any of the various operations described herein (e.g., operations performed by logic devices of various devices of the system 1200).

In addition, a machine-readable medium may be provided for storing non-transitory instructions for loading into and execution by the controller 1230. In these and other embodiments, the controller 1230 may be implemented with other components where appropriate, such as volatile memory, non-volatile memory, one or more interfaces, and/or various analog and/or digital components for interfacing with devices of the system 1200. For example, the controller 1230 may be adapted to store sensor signals, sensor information, parameters for coordinate frame transformations, calibration parameters, sets of calibration points, and/or other operational parameters, over time, for example, and provide such stored data to a user using the user interface 1220. In some embodiments, the controller 1230 may be integrated with one or more user interfaces (e.g., user interface 1220), and, in one embodiment, may share a communication module or modules. As noted herein, the controller 1230 may be adapted to execute one or more control loops for actuated device control, steering control (e.g., using the steering sensor/actuator 1250) and/or performing other various operations of the mobile structure 1201 and/or system 1200. In some embodiments, a control loop may include processing sensor signals and/or sensor information in order to control one or more operations of the sonar system 1210, radar system 1260, mobile structure 1201, and/or system 1200.

For example, the controller 1230 may be adapted to receive a measured heading 1207 of the mobile structure 1201 from the orientation sensor 1240, a measured steering rate (e.g., a measured yaw rate, in some embodiments) from the gyroscope/accelerometer 1244, a measured speed from the speed sensor 1242, a measured position or series of absolute and/or relative positions from the GNSS 1246, a measured steering angle from the steering sensor/actuator 1250, and/or a user input from the user interface 1220. In some embodiments, a user input may include a target heading, for example, an absolute position and/or waypoint (e.g., from which the target heading may be derived), and/or one or more other control loop parameters. In further embodiments, the controller 1230 may be adapted to determine a steering demand or other control signal for the OPS 1290 based on one or more of the received sensor signals, including the user input, and provide the steering demand/control signal to the steering sensor/actuator 1250 and/or OPS 1290.

The OPS 1290 may be implemented as an integrated selection of orientation and/or position sensors (e.g., orientation sensor 1240, accelerometer/gyroscope 1244, GNSS 1246) that is configured to provide orientation and/or position data in relation to one or more elements of the system 1200. For example, embodiments of the OPS 1290 may be integrated with the mobile structure 1201, sonar system 1210, and/or radar system 1260 and be configured to provide orientation and/or position data corresponding to a center of mass of the mobile structure 1201, a sonar transducer of the sonar system 1210, and/or a radar antenna/transducer of the radar system 1260. Such measurements may be referenced to an absolute coordinate frame, for example, or may be referenced to a coordinate frame of the OPS 1290 and/or any one of the individual sensors integrated with the OPS 1290. More generally, the OPS 1290 provides a single, relatively compact integrated device that can be replicated throughout various elements of the system 1200, which in some embodiments may include a single/simplified interface for data and/or power. In various embodiments, the coordinate frames for one or more of the orientation and/or position sensors integrated into the OPS 1290 may be referenced to each other (e.g., to a single coordinate frame for the OPS 1290), such as at time of manufacture, to reduce or eliminate a need to determine coordinate frame transformations to combine data from multiple sensors of the OPS 1290 during operation of the system 1200.

The orientation sensor 1240 may be implemented as one or more of a compass, float, accelerometer, magnetometer, and/or other digital or analog device capable of measuring an orientation of the mobile structure 1201 (e.g., magnitude and direction of roll, pitch, and/or yaw, relative to one or more reference orientations such as gravity and/or Magnetic North) and providing such measurements as sensor signals that may be communicated to various devices of the system 1200. In some embodiments, the orientation sensor 1240 may be adapted to provide heading measurements for the mobile structure 1201. In other embodiments, the orientation sensor 1240 may be adapted to provide roll, pitch, and/or yaw rates for the mobile structure 1201 (e.g., using a time series of orientation measurements). The orientation sensor 1240 may be positioned and/or adapted to make orientation measurements in relation to a particular coordinate frame of the mobile structure 1201, for example. In such embodiments, the controller 1230 may be configured to determine a compensated yaw rate based on the provided sensor signals. In various embodiments, a yaw rate and/or compensated yaw rate may be approximately equal to a steering rate of the mobile structure 1201.

The speed sensor 1242 may be implemented as an electronic pitot tube, metered gear or wheel, water speed sensor, wind speed sensor, a wind velocity sensor (e.g., direction and magnitude) and/or other device capable of measuring or determining a linear speed of the mobile structure 1201 (e.g., in a surrounding medium and/or aligned with a longitudinal axis of the mobile structure 1201) and providing such measurements as sensor signals that may be communicated to various devices of the system 1200. In some embodiments, the speed sensor 1242 may be adapted to provide a velocity of a surrounding medium relative to the sensor 1242 and/or mobile structure 1201. For example, the speed sensor 1242 may be configured to provide an absolute or relative wind velocity or water velocity impacting the mobile structure 1201. In various embodiments, the system 1200 may include multiple embodiments of the speed sensor 1242, such as one wind velocity sensor and one water velocity sensor.

The gyroscope/accelerometer 1244 may be implemented as one or more electronic sextants, semiconductor devices, integrated chips, accelerometer sensors, accelerometer sensor systems, or other devices capable of measuring angular velocities/accelerations and/or linear accelerations (e.g., direction and magnitude) of the mobile structure 1201 and providing such measurements as sensor signals that may be communicated to other devices of the system 1200 (e.g., user interface 1220, controller 1230). In some embodiments, the gyroscope/accelerometer 1244 may be adapted to determine pitch, pitch rate, roll, roll rate, yaw, yaw rate, compensated yaw rate, an absolute speed, and/or a linear acceleration rate of the mobile structure 1201. Thus, the gyroscope/accelerometer 1244 may be adapted to provide a measured heading, a measured steering rate, and/or a measured speed for the mobile structure 1201. In some embodiments, the gyroscope/accelerometer 1244 may provide pitch rate, roll rate, yaw rate, and/or a linear acceleration of the mobile structure 1201 to the controller 1230 and the controller 1230 may be adapted to determine a compensated yaw rate based on the provided sensor signals. The gyroscope/accelerometer 1244 may be positioned and/or adapted to make such measurements in relation to a particular coordinate frame of the mobile structure 1201, for example. In various embodiments, gyroscope/accelerometer 1244 may be implemented in a common housing and/or module to ensure a common reference frame or a known transformation between reference frames.

The GNSS 1246 may be implemented as a global navigation satellite system receiver, such as a GNSS receiver, and/or other device capable of determining absolute and/or relative position of the mobile structure 1201 (e.g., or an element of the mobile structure 1201, such as the sonar system 1210, radar system 1260, and/or user interface 1220) based on wireless signals received from space-born and/or terrestrial sources, for example, and capable of providing such measurements as sensor signals that may be communicated to various devices of the system 1200. More generally, the GNSS 1246 may be implemented by any one or combination of a number of different GNSSs. In some embodiments, the GNSS 1246 may be used to determine a velocity, speed, COG, SOG, track, and/or yaw rate of the mobile structure 1201 (e.g., using a time series of position measurements), such as an absolute velocity and/or a yaw component of an angular velocity of the mobile structure 1201. In various embodiments, one or more logic devices of the system 1200 may be adapted to determine a calculated speed of the mobile structure 1201 and/or a computed yaw component of the angular velocity from such sensor information. The GNSS 1246 may also be used to estimate a relative wind velocity or a water current velocity, for example, using a time series of position measurements while mobile structure is otherwise lacking powered navigation control.

The steering sensor/actuator 1250 may be adapted to physically adjust a heading of the mobile structure 1201 according to one or more control signals, user inputs, and/or stabilized attitude estimates provided by a logic device of the system 1200, such as the controller 1230. The steering sensor/actuator 1250 may include one or more actuators and control surfaces (e.g., a rudder or other type of steering or trim mechanism) of the mobile structure 1201, and may be adapted to physically adjust the control surfaces to a variety of positive and/or negative steering angles/positions.

The propulsion system 1270 may be implemented as a propeller, turbine, or other thrust-based propulsion system, a mechanical wheeled and/or tracked propulsion system, a sail-based propulsion system, and/or other types of propulsion systems that can be used to provide motive force to the mobile structure 1201. In some embodiments, the propulsion system 1270 may be non-articulated, for example, such that the direction of motive force and/or thrust generated by the propulsion system 1270 is fixed relative to a coordinate frame of the mobile structure 1201. Non-limiting examples of non-articulated propulsion systems include, for example, an inboard motor for a watercraft with a fixed thrust vector, for example, or a fixed aircraft propeller or turbine. In other embodiments, the propulsion system 1270 may be articulated, for example, and may be coupled to and/or integrated with the steering sensor/actuator 1250, for example, such that the direction of generated motive force and/or thrust is variable relative to a coordinate frame of the mobile structure 1201. Non-limiting examples of articulated propulsion systems include, for example, an outboard motor for a watercraft, an inboard motor for a watercraft with a variable thrust vector/port (e.g., used to steer the watercraft), a sail, or an aircraft propeller or turbine with a variable thrust vector, for example. As such, in some embodiments, the propulsion system 1270 may be integrated with the steering sensor/actuator 1250.

Other modules 1280 may include other and/or additional sensors, actuators, communications modules/nodes, and/or user interface devices used to provide additional environmental information of the mobile structure 1201, for example. In some embodiments, other modules 1280 may include a humidity sensor, a wind and/or water temperature sensor, a barometer, a radar system, a visible spectrum camera, an infrared camera, and/or other environmental sensors providing measurements and/or other sensor signals that can be displayed to a user and/or used by other devices of the system 1200 (e.g., controller 1230) to provide operational control of the mobile structure 1201 and/or system 1200 that compensates for environmental conditions, such as wind speed and/or direction, swell speed, amplitude, and/or direction, and/or an object in a path of the mobile structure 1201, for example.

In some embodiments, other modules 1280 may include one or more actuated devices (e.g., spotlights, infrared illuminators, cameras, radars, sonars, lidars, other ranging systems, and/or other actuated devices) coupled to the mobile structure 1201, where each actuated device includes one or more actuators adapted to adjust an orientation of the device, relative to the mobile structure 1201, in response to one or more control signals (e.g., provided by the controller 1230). Other modules 1280 may include a sensing element angle sensor, for example, which may be physically coupled to a radar assembly housing of the radar system 1260 and be configured to measure an angle between an orientation of an antenna/sensing element and a longitudinal axis of the housing and/or mobile structure 1201. Other modules 1280 may also include a rotating antenna platform and/or corresponding platform actuator for the radar system 1260. In some embodiments, other modules 1280 may include one or more Helmholtz coils integrated with the OPS 1290, for example, and be configured to selectively cancel out one or more components of the Earth's magnetic field.

In general, each of the elements of the system 1200 may be implemented with any appropriate logic device (e.g., processing device, microcontroller, processor, application specific integrated circuit (ASIC), field programmable gate array (FPGA), memory storage device, memory reader, or other device or combinations of devices) that may be adapted to execute, store, and/or receive appropriate instructions, such as software instructions implementing a method for providing sonar data and/or imagery, for example, or for transmitting and/or receiving communications, such as sensor signals, sensor information, and/or control signals, between one or more devices of the system 1200. In one embodiment, such method may include instructions to receive an orientation, acceleration, position, and/or speed of the mobile structure 1201 and/or sonar system 1210 from various sensors, to determine a transducer orientation adjustment (e.g., relative to a desired transducer orientation) from the sensor signals, and/or to control an actuator to adjust a transducer orientation accordingly, for example, as described herein. In a further embodiment, such method may include instructions for forming one or more communication links between various devices of the system 1200.

In addition, one or more machine readable mediums may be provided for storing non-transitory instructions for loading into and execution by any logic device implemented with one or more of the devices of the system 1200. In these and other embodiments, the logic devices may be implemented with other components where appropriate, such as volatile memory, non-volatile memory, and/or one or more interfaces (e.g., inter-integrated circuit (I2C) interfaces, mobile industry processor interfaces (MIPI), joint test action group (JTAG) interfaces (e.g., IEEE 1149.1 standard test access port and boundary-scan architecture), controller area network (CAN) bus interfaces, and/or other interfaces, such as an interface for one or more antennas, or an interface for a particular type of sensor).

Each of the elements of the system 1200 may be implemented with one or more amplifiers, modulators, phase adjusters, beamforming components, digital to analog converters (DACs), analog to digital converters (ADCs), various interfaces, antennas, transducers, and/or other analog and/or digital components enabling each of the devices of the system 1200 to transmit and/or receive signals, for example, in order to facilitate wired and/or wireless communications between one or more devices of the system 1200. Such components may be integrated with a corresponding element of the system 1200, for example. In some embodiments, the same or similar components may be used to perform one or more sensor measurements, as described herein.

For example, the same or similar components may be used to create an acoustic pulse (e.g., a transmission control signal and/or a digital shaping control signal), convert the acoustic pulse to an excitation signal (e.g., a shaped or unshaped transmission signal) and transmit it to a sonar transducer element to produce an acoustic beam, receive an acoustic return (e.g., a sound wave received by the sonar transducer element and/or corresponding electrical signals from the sonar transducer element), convert the acoustic return to acoustic return data, and/or store sensor information, configuration data, and/or other data corresponding to operation of a sonar system, as described herein. Similarly, the same or similar components may be used to create a radar pulse (e.g., a transmission control signal and/or a digital shaping control signal), convert the radar pulse to an excitation signal (e.g., a shaped or unshaped transmission signal) and transmit it to a radar antenna to produce a radar beam, receive a radar return (e.g., an electromagnetic wave received by the radar antenna and/or corresponding electrical signals from the radar antenna), convert the radar return to radar return data, and/or store sensor information, configuration data, and/or other data corresponding to operation of a radar system, as described herein.

Sensor signals, control signals, and other signals may be communicated among elements of the system 1200 using a variety of wired and/or wireless communication techniques, including voltage signaling, Ethernet, WiFi, Bluetooth, Zigbee, Xbee, Micronet, CAN bus, or other medium and/or short range wired and/or wireless networking protocols and/or implementations, for example. In such embodiments, each element of the system 1200 may include one or more modules supporting wired, wireless, and/or a combination of wired and wireless communication techniques.

In some embodiments, various elements or portions of elements of the system 1200 may be integrated with each other, for example, or may be integrated onto a single printed circuit board (PCB) to reduce system complexity, manufacturing costs, power requirements, and/or timing errors between the various sensor measurements. For example, the gyroscope/accelerometer 1244, user interface 1220, and controller 1230 may be configured to share one or more components, such as a memory, a logic device, a communications module, and/or other components, and such sharing may act to reduce and/or substantially eliminate such timing errors while reducing overall system complexity and/or cost.

Each element of the system 1200 may include one or more batteries or other electrical power storage devices, for example, and may include one or more solar cells or other electrical power generating devices (e.g., a wind or water-powered turbine, or a generator producing electrical power from motion of one or more elements of the system 1200). In some embodiments, one or more of the devices may be powered by a power source for the mobile structure 1201, using one or more power leads. Such power leads may also be used to support one or more communication techniques between elements of the system 1200.

In various embodiments, a logic device of the system 1200 (e.g., of the orientation sensor 1240 and/or other elements of the system 1200) may be adapted to determine parameters (e.g., using signals from various devices of the system 1200) for transforming a coordinate frame of the sonar system 1210 and/or other sensors of the system 1200 to/from a coordinate frame of the mobile structure 1201, at-rest and/or in-motion, and/or other coordinate frames, as described herein. One or more logic devices of the system 1200 may be adapted to use such parameters to transform a coordinate frame of the sonar system 1210, radar system 1260, and/or other sensors of the system 1200 to/from a coordinate frame of the orientation sensor 1240 and/or mobile structure 1201, for example. Furthermore, such parameters may be used to determine and/or calculate one or more adjustments to an orientation of the sonar system 1210 and/or radar system 1260 that would be necessary to physically align a coordinate frame of the sonar system 1210 and/or radar system 1260 with a coordinate frame of the orientation sensor 1240 and/or mobile structure 1201, for example, or an absolute coordinate frame. Adjustments determined from such parameters may be used to selectively power adjustment servos/actuators (e.g., of the sonar system 1210, radar system 1260, and/or other sensors or elements of the system 1200), for example, or may be communicated to a user through the user interface 1220, as described herein.

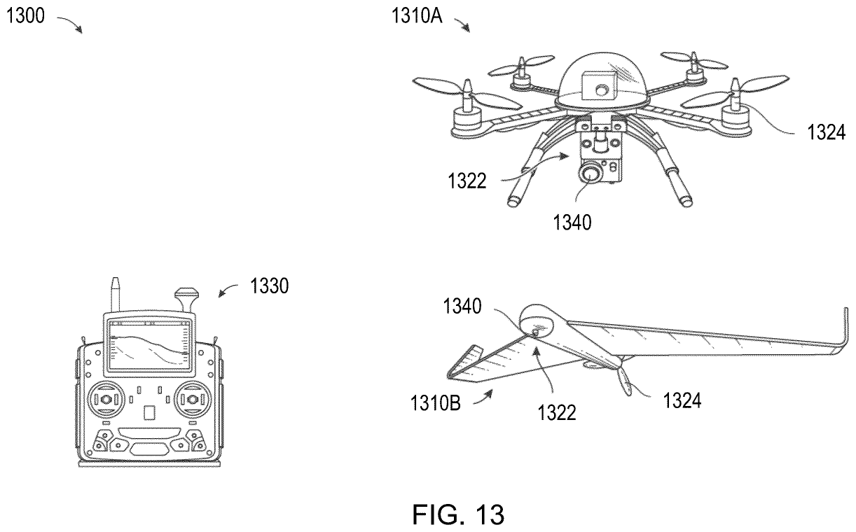

FIG. 13 illustrates an example survey system 1300 including mobile platforms 1310A and 1310B, each with sensor payloads 1340 and associated gimbal systems 1322 in accordance with one or more embodiments of the present disclosure. The system 1300 may be implemented to provide radar data, sonar data, and/or imagery for use with operation of the mobile platform 1310A and/or 1310B. In some embodiments, the mobile platform 1310A and/or 1310B may be, may include, may be a part of, may include one or more components of the mobile structure 1201 of FIG. 12. In the embodiment shown in FIG. 13, the survey system 1300 includes a base station 1330, the mobile platform 1310A with sensor payload 1340 and gimbal system 1322, and the mobile platform 1310B with sensor payload 1340 and gimbal system 1322, where the base station 1330 may be configured to control motion, position, and/or orientation of the mobile platform 1310A, mobile platform 1310B, and/or sensor payloads 1340. More generally, the survey system 1300 may include any number of the mobile platforms 1310A and/or 1310B. In some embodiments, the mobile platforms 1310A and/or 1310B may be nodes participating in a mesh network, in some cases along with additional nodes, such as mobile platforms and base stations, of the mesh network. The nodes of the mesh network may exchange information about their respective positions with neighboring nodes. In some embodiments, the nodes may exchange information about their respective positions with neighboring nodes in accordance with a Cursor-on-Target (CoT) communication protocol. In further embodiments, the position information shared between nodes may include GPS coordinate positions for the respective nodes.

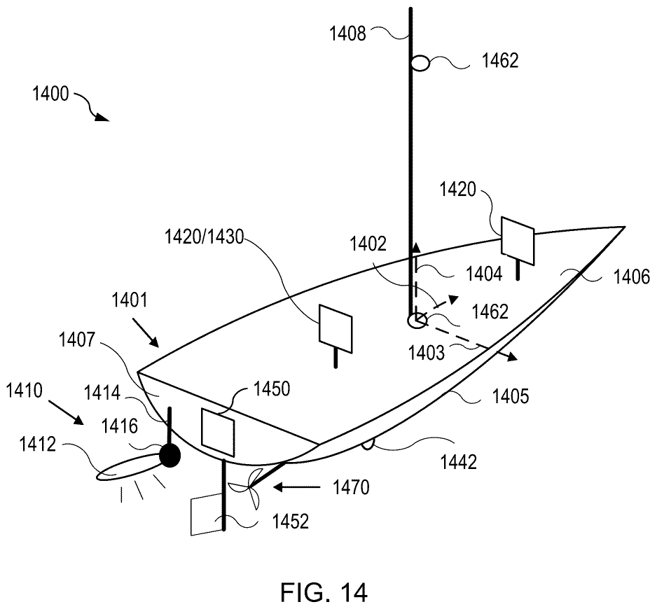

FIG. 14 illustrates an example system 1400 in accordance with one or more embodiments of the present disclosure. In the embodiment shown in FIG. 14, the system 1400 may be implemented to provide radar data, sonar data, and/or imagery for use with operation of a mobile structure 1401. In some embodiments, the mobile structure 1401 may be, may include, may be a part of, may include one or more components of the mobile structure 1201 of FIG. 12. For example, the system 1400B may include a multichannel sonar system 1410, an integrated user interface/controller 1420/1430, a secondary user interface 1420, a steering sensor/actuator 1450, sensor clusters 1462 (e.g., orientation sensor 1240, gyroscope/accelerometer 1244, and/or GNSS 1246), and various other sensors and/or actuators. In the embodiment illustrated by FIG. 14, the mobile structure 1401 is implemented as a motorized boat including a hull 1405, a deck 1406, a transom 1407, a mast/sensor mount 1408, a rudder 1452, an inboard motor 1470, and an actuated multichannel sonar system 1410 coupled to the transom 1407. In other embodiments, the hull 1405, deck 1406, mast/sensor mount 1408, rudder 1452, inboard motor 1470, and various actuated devices may correspond to attributes of a passenger aircraft or other type of vehicle, robot, or drone, for example, such as an undercarriage, a passenger compartment, an engine/engine compartment, a trunk, a roof, a steering mechanism, a headlight, a radar system, and/or other portions of a vehicle.

As depicted in FIG. 14, the mobile structure 1401 includes the actuated multichannel sonar system 1410, which in turn includes a transducer assembly 1412 coupled to the transom 1407 of the mobile structure 1401 through an assembly bracket/actuator 1416 and a transom bracket/electrical conduit 1414. In some embodiments, the assembly bracket/actuator 1416 may be implemented as a roll, pitch, and/or yaw actuator, for example, and may be adapted to adjust an orientation of the transducer assembly 1412 according to control signals and/or an orientation (e.g., roll, pitch, and/or yaw) or position of the mobile structure 1401 provided by the user interface/controller 1420/1430. For example, the user interface/controller 1420/1430 may be adapted to receive an orientation of the transducer assembly 1412 configured to ensonify a portion of surrounding water and/or a direction referenced to an absolute coordinate frame, and to adjust an orientation of the transducer assembly 1412 to retain ensonification of the position and/or direction in response to motion of the mobile structure 1401, using one or more orientations and/or positions of the mobile structure 1401 and/or other sensor information derived by executing various methods described herein. In another embodiment, the user interface/controller 1420/1430 may be configured to adjust an orientation of the transducer assembly 1412 to direct sonar transmissions from the transducer assembly 1412 substantially downwards and/or along an underwater track during motion of the mobile structure 1401. In such embodiment, the underwater track may be predetermined, for example, or may be determined based on criteria parameters, such as a minimum allowable depth, a maximum ensonified depth, a bathymetric route, and/or other criteria parameters.

In one embodiment, the user interfaces 1420 may be mounted to the mobile structure 1401 substantially on the deck 1406 and/or the mast/sensor mount 1408. Such mounts may be fixed, for example, or may include gimbals and other leveling mechanisms/actuators so that a display of the user interfaces 1420 stays substantially level with respect to a horizon and/or a “down” vector (e.g., to mimic typical user head motion/orientation). In another embodiment, at least one of the user interfaces 1420 may be located in proximity to the mobile structure 1401 and be mobile throughout a user level (e.g., deck 1406b) of the mobile structure 1401. For example, the secondary user interface 1420 may be implemented with a lanyard and/or other type of strap and/or attachment device and be physically coupled to a user of the mobile structure 1401 so as to be in proximity to the mobile structure 1401. In various embodiments, the user interfaces 1420 may be implemented with a relatively thin display that is integrated into a PCB of the corresponding user interface in order to reduce size, weight, housing complexity, and/or manufacturing costs.

As shown in FIG. 14, in some embodiments, a speed sensor 1442 may be mounted to a portion of the mobile structure 1401, such as to the hull 1405, and be adapted to measure a relative water speed. In some embodiments, the speed sensor 1442 may be adapted to provide a thin profile to reduce and/or avoid water drag. In various embodiments, the speed sensor 1442 may be mounted to a portion of the mobile structure 1401 that is substantially outside (e.g., for easy operational accessibility). The speed sensor 1442 may include one or more batteries and/or other electrical power storage devices, for example, and may include one or more water-powered turbines to generate electrical power. In other embodiments, the speed sensor 1442 may be powered by a power source for the mobile structure 1401, for example, using one or more power leads penetrating the hull 1405. In alternative embodiments, the speed sensor 1442 may be implemented as a wind velocity sensor, for example, and may be mounted to the mast/sensor mount 1408b to have relatively clear access to local wind.

In the embodiment illustrated by FIG. 14, the mobile structure 1401 includes a direction/longitudinal axis 1402, direction/lateral axis 1403, and direction/vertical axis 1404 meeting approximately at the mast/sensor mount 1408 (e.g., near a center of gravity of the mobile structure 1401). In one embodiment, the various axes may define a coordinate frame of the mobile structure 1401 and/or sensor clusters 1462. Each sensor adapted to measure a direction (e.g., velocities, accelerations, headings, or other states including a directional component) may be implemented with a mount, actuators, and/or servos that can be used to align a coordinate frame of the sensor with a coordinate frame of any element of the system 1400 and/or mobile structure 1401. Each element of the system 1400 may be located at positions different from those depicted in FIG. 14. Each device of the system 1400 may include one or more batteries or other electrical power storage devices, for example, and may include one or more solar cells or other electrical power generating devices. In some embodiments, one or more of the devices may be powered by a power source for the mobile structure 1401. As noted herein, each element of the system 1400 may be implemented with an antenna, a logic device, and/or other analog and/or digital components enabling that element to provide, receive, and process sensor signals and interface or communicate with one or more devices of the system 1400. Further, a logic device of that element may be adapted to perform any of the methods described herein.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

The foregoing description is not intended to limit the present disclosure to the precise forms or particular fields of use disclosed. Embodiments described above illustrate but do not limit the invention. It is contemplated that various alternate embodiments and/or modifications to the present invention, whether explicitly described or implied herein, are possible in light of the disclosure. Accordingly, the scope of the invention is defined only by the following claims.

What is claimed is:

1. A method comprising:
determining a first set of antenna positions associated with an antenna array;
determining at least one characteristic associated with the first set of antenna positions;
determining a score associated with the first set of antenna positions based on the at least one characteristic; and
adjusting, based at least on the score, the first set of antenna positions to obtain a second set of antenna positions associated with the antenna array.

2. The method of claim 1, further comprising determining at least one metric associated with the first set of antenna positions based on the at least one characteristic, wherein each metric is associated with one characteristic of the at least one characteristic, and wherein the score is determined based on the at least one metric.

3. The method of claim 1, wherein the at least one characteristic comprises a level of ground sidelobes, a level of sidelobes in a field of view of the antenna array, an azimuth accuracy, an elevation accuracy, an ability to mitigate or reduce an impact of interference and/or multi-path effects with the ground, a beamwidth associated with the antenna array in an azimuth plane, and/or a beamformed response.

4. The method of claim 1, wherein the at least one characteristic comprises a plurality of characteristics, wherein the at least one metric comprises a plurality of metrics, wherein each metric is associated with a respective weight, and wherein the score is determined based on a weighted combination of the plurality of metrics.

5. The method of claim 1, further comprising determining, based on the score and a threshold score, whether to adjust the first set of antenna positions, wherein the adjusting is performed in response to a determination to adjust the first set of antenna positions.

6. The method of claim 1, further comprising:
determining at least one characteristic associated with the second set of antenna positions;
determining a score associated with the second set of antenna positions based on the at least one characteristic associated with the second set of antenna positions; and
determining whether to adjust the second set of antenna positions based on the score associated with the second set of antenna positions.

7. The method of claim 1, wherein the second set of antenna positions provides an antenna position of each of a plurality of antenna elements of the antenna array such that the plurality of antenna elements are arranged in a staggered arrangement according to the second set of antenna positions, and wherein the plurality of antenna elements comprises a single line of antenna elements separated along a first direction and with each antenna element at a respective distance along a second direction from a first reference axis parallel to the first direction, and wherein the first direction is perpendicular from the second direction.

8. The method of claim 7, wherein the single line of antenna elements are arranged in a symmetric or substantially symmetric arrangement relative to a second reference axis parallel to the second direction.

9. The method of claim 1, wherein the at least one characteristic comprises a mean level of ground sidelobes level, wherein the method further comprises determining a ground sidelobe metric based on the mean level of ground sidelobes, and wherein the score is determined based on the ground sidelobe metric.

10. A ranging system having an antenna array with a plurality of antenna elements positioned according to the method of claim 1.

11. A ranging system comprising:
an antenna array configured to transmit ranging signals and/or receive ranging signals, wherein the antenna array comprises a single line of antenna elements arranged in a staggered arrangement in which the antenna elements are separated along a first direction and each antenna element is at a respective distance along a second direction from a first reference axis parallel to the first direction, and wherein the first direction is perpendicular to the second direction.

12. The ranging system of claim 11, wherein the ranging system comprises a radar system.

13. The ranging system of claim 11, wherein the single line of antenna elements are arranged in a symmetric arrangement relative to a second reference axis parallel to the second direction.

14. The ranging system of claim 11, wherein the single line of antenna elements are arranged in an asymmetric arrangement relative to a second reference axis parallel to the second direction.

15. The ranging system of claim 11, wherein a center of the single line of antenna elements divides the single line of antenna elements into two subsets of antenna elements having the same number of antenna elements and is at an intersection of the first reference axis and a second reference axis parallel to the second direction, and wherein the antenna elements of the single line fluctuate about the first reference axis such that a first subset of adjacent antenna elements of the single line that are farther from the center have an average distance along the second direction from the first reference axis larger than an average distance along the second direction from the first reference axis for a second subset of adjacent antenna elements of the single line that are closer to the center.

16. The ranging system of claim 11, wherein a center of the single line of antenna elements divides the single line of antenna elements into two subsets of antenna elements having the same number of antenna elements and is at an intersection of the first reference axis and a second reference axis parallel to the second direction, and wherein the antenna elements of the single line fluctuate about the first reference axis such that a first subset of adjacent antenna elements of the single line that are farther from the center have an average distance along the second direction from the first reference axis smaller than an average distance along the second direction from the first reference axis for a second subset of adjacent antenna elements of the single line that are closer to the center.

17. The ranging system of claim 11, wherein:
a subset of adjacent antenna elements of the single line comprises a first antenna element, a second antenna element adjacent to the first antenna element, and a third antenna element adjacent to the second antenna element;
the first antenna element is closer to the center than the second antenna element; and
a distance between the first antenna element and the second antenna element along the second direction is less than a distance between the second antenna element and the third antenna element along the second direction.

18. The ranging system of claim 11, wherein:
a subset of adjacent antenna elements of the single line comprises a first antenna element and a second antenna element adjacent to the first antenna element;
the first antenna element is closer to the center than the second antenna element and is at a first negative distance from the first reference axis; and
the second antenna element is at a positive distance from the first reference axis.

19. The ranging system of claim 18, wherein the subset further comprises a third antenna element adjacent to the second antenna element, wherein the third antenna element is at a second negative distance from the first reference axis.

20. The ranging system of claim 18, wherein the first negative distance is approximately between −3 operating wavelengths to −5 operating wavelengths from the first reference axis, and wherein the positive distance is approximately between +3 operating wavelengths to +5 operating wavelengths from the first reference axis.
